(19) United States
(12) Patent Application Publication
(10) Pub. No.: US 2026/0001132 A1
(43) Pub. Date: Jan. 1, 2026

(54) DEFECT ESTIMATION DEVICE, NUMERICAL CONTROL DEVICE, ADDITIVE MANUFACTURING APPARATUS, AND DEFECT ESTIMATION METHOD

(71) Applicant: Mitsubishi Electric Corporation, Tokyo (JP)

(72) Inventors: Yoshiyuki MATSUI, Tokyo (JP); Nobuyuki SUMI, Tokyo (JP); Shun KAYASHIMA, Tokyo (JP)

(73) Assignee: Mitsubishi Electric Corporation, Tokyo (JP)

(21) Appl. No.: 19/131,969

(22) PCT Filed: Feb. 8, 2023
(86) PCT No.: PCT/JP2023/004099

§ 371 Date: May 22, 2025

(51) Int. Cl. B22F 10/30; B22F 10/85; B33Y 50/02

(52) U.S. Cl. CPC B22F 10/30; B22F 10/85; B33Y 50/02

(57) ABSTRACT

A defect estimation device estimates a state of an internal defect that is a gap formed inside an object manufactured by supplying a material to a workpiece and stacking beads formed of the material melted using a beam. The defect estimation device includes a defect estimation unit that determines presence or absence of at least one of a first phenomenon that is a phenomenon in which the material unmelted collides with the workpiece, a second phenomenon that is a phenomenon in which the material unmelted is rubbed against the bead to generate a trace on the bead, and a third phenomenon that is a phenomenon in which a gap is generated between beads adjacent to each other, and obtains defect information indicating the state of the internal defect based on a determination result.

### FIELD

The present disclosure relates to a defect estimation device, a numerical control device, an additive manufacturing apparatus, and a defect estimation method for estimating an internal defect in a three-dimensional object.

### BACKGROUND

Additive manufacturing (AM) is known as a method for manufacturing a three-dimensional object. Directed energy deposition (DED) is one of multiple types of additive manufacturing methods, in which a workpiece is irradiated with a beam and material is supplied to the irradiation position, whereby the material is melted and shaped.

Internal defects may occur in an object manufactured by additive manufacturing. An internal defect is a gap formed inside the object. The internal defect is formed because the material is not sufficiently provided at the time of manufacturing. Since the place where the internal defect occurs is likely to become the starting point of a crack, the internal defect may be a factor that lowers the mechanical strength of the object. From the viewpoint of ensuring traceability, it is important to grasp the presence or absence of an internal defect, the position of the internal defect, the size of the internal defect, and the like of the object.

One of the methods for evaluating internal defects is a fracture test. Since it is difficult to use the fracture test for total inspection, the fracture test is used for sampling inspection. Another known evaluation method is to detect an internal defect through radiographic inspection by X-ray computed tomography (CT), through ultrasonic flaw inspection, or the like. For these inspections, there are restrictions on the shape of the inspection target or the material of the inspection target, and thus it may be difficult to detect an internal defect in the object. Furthermore, in any of these evaluation methods, a measurement step of measuring the position of the internal defect, the size of the internal defect, or the like is required separately from the shaping step. Since the measurement step is required, the machining time increases by the amount of the measurement step.

Patent Literature 1 relates to an additive manufacturing system that performs shaping using a welding torch attached to a robot, and discloses measuring a surface temperature distribution of a bead formed of a molten material and detecting an internal defect based on a temperature gradient obtained from the surface temperature distribution of the bead.

### Citation List

### Patent Literature

Patent Literature 1: Japanese Patent Application Laid-open No. 2020-189324

### SUMMARY OF INVENTION

### Problem to be Solved by the Invention

According to the conventional technique described in Patent Literature 1, measurement is performed on a formed bead in order to detect an internal defect. According to the conventional technique, since the additive manufacturing system needs to introduce a measurement instrument for detecting an internal defect, there is a problem in that a configuration for detecting the internal defect becomes complicated and equipment cost is high. In addition, according to the conventional technique, since the measurement is performed on the formed bead, there is a problem that the machining time increases by the amount of the measurement step. Therefore, it has been required to be able to grasp the state of the internal defect in the object with a simple configuration and without increasing the machining time.

The present disclosure has been made in view of the above, and an object thereof is to obtain a defect estimation device capable of grasping the state of an internal defect in an object with a simple configuration and without increasing the machining time.

### Means to Solve the Problem

To solve the above problem and achieve an object, a defect estimation device according to the present disclosure is a defect estimation device that estimates a state of an internal defect that is a gap formed inside an object manufactured by supplying a material to a workpiece and stacking beads formed of the material melted using a beam. The defect estimation device includes: a defect estimation unit to determine presence or absence of at least one of a first phenomenon that is a phenomenon in which the material unmelted collides with the workpiece, a second phenomenon that is a phenomenon in which the material unmelted is rubbed against the bead to generate a trace on the bead, and a third phenomenon that is a phenomenon in which a gap is generated between beads adjacent to each other, and obtain defect information indicating the state of the internal defect based on a determination result.

### Effects of the Invention

The defect estimation device according to the present disclosure can achieve the effect of enabling the state of an internal defect in an object to be grasped with a simple configuration and without increasing the machining time.

### BRIEF DESCRIPTION OF DRAWINGS

FIG. 1 is a diagram illustrating an exemplary configuration of an additive manufacturing apparatus according to the first embodiment.

FIG. 2 is a diagram illustrating an exemplary functional configuration of the NC device provided in the additive manufacturing apparatus according to the first embodiment.

FIG. 3 is a diagram for explaining formation of the object by the additive manufacturing apparatus according to the first embodiment.

FIG. 4 is a diagram for explaining calculation of the wire melting position according to the first embodiment.

FIG. 5 is a diagram for explaining calculation of the bead height according to the first embodiment.

FIG. 6 is a schematic diagram of a molten pool image used for calculating the bead width in the first embodiment.

FIG. 7 is a diagram for explaining occurrence of the stub phenomenon in the additive manufacturing apparatus according to the first embodiment.

FIG. 8 is a first diagram for explaining the relationship between the state of the stub phenomenon occurring in the additive manufacturing apparatus according to the first embodiment and the internal defect.

FIG. 9 is a diagram illustrating an example of an internal defect occurring in case (a) illustrated in FIG. 8.

FIG. 10 is a diagram illustrating an example of an 10 internal defect occurring in case (b) illustrated in FIG. 8.

FIG. 11 is a second diagram for explaining the relationship between the state of the stub phenomenon occurring in the additive manufacturing apparatus according to the first embodiment and the internal defect.

FIG. 12 is a diagram illustrating an example of an internal defect occurring in case illustrated in FIG. 11.

FIG. 13 is a third diagram for explaining the relationship between the state of the stub phenomenon occurring in the additive manufacturing apparatus according to the first embodiment and the internal defect.

FIG. 14 is a diagram illustrating an example of an internal defect occurring in the case illustrated in FIG. 13.

FIG. 15 is a fourth diagram for explaining the relationship between the state of the stub phenomenon occurring in the additive manufacturing apparatus according to the first embodiment and the internal defect.

FIG. 16 is a diagram for explaining occurrence of the wire rubbing phenomenon in the additive manufacturing apparatus according to the first embodiment.

FIG. 17 is a fourth diagram for explaining the relationship between the wire rubbing phenomenon occurring in the additive manufacturing apparatus according to the first embodiment and the internal defect.

FIG. 18 is a diagram illustrating an example of an internal defect occurring in case (a) illustrated in FIG. 17.

FIG. 19 is a diagram illustrating an example of an internal defect occurring in case (b) illustrated in FIG. 17.

FIG. 20 is a second diagram for explaining the relationship between the wire rubbing phenomenon occurring in the additive manufacturing apparatus according to the first embodiment and the internal defect.

FIG. 21 is a diagram for explaining occurrence of the bead gap phenomenon in the additive manufacturing apparatus according to the first embodiment.

FIG. 22 is a first diagram illustrating formation of beads adjacent to each other by the additive manufacturing apparatus according to the first embodiment.

FIG. 23 is a cross-sectional diagram taken along line XXIII-XXIII of the bead illustrated in FIG. 22.

FIG. 24 is a cross-sectional diagram illustrating stacking of the bead on the bead illustrated in FIG. 23.

FIG. 25 is a second diagram illustrating formation of beads adjacent to each other by the additive manufacturing apparatus according to the first embodiment.

FIG. 26 is a cross-sectional diagram taken along line XXVI-XXVI of the bead illustrated in FIG. 25.

FIG. 27 is a cross-sectional diagram illustrating stacking of the bead on the bead illustrated in FIG. 26.

FIG. 28 is a diagram for explaining the relationship between the bead width and the threshold in the additive manufacturing apparatus according to the first embodiment.

FIG. 29 is a diagram for explaining a method of adding information to the fabrication model by the defect information drawing unit in the first embodiment.

FIG. 30 is a flowchart illustrating a procedure of operation by the additive manufacturing apparatus according to the first embodiment.

FIG. 31 is a diagram for explaining a method of obtaining bead height data by the additive manufacturing apparatus according to the second embodiment.

FIG. 32 is a diagram illustrating an exemplary configuration of an additive manufacturing apparatus according to the third embodiment.

FIG. 33 is a first diagram for explaining detection of the force acting on the wire and the moment acting on the wire by the load sensor of the additive manufacturing apparatus according to the third embodiment.

FIG. 34 is a second diagram for explaining detection of the force acting on the wire and the moment acting on the wire by the load sensor of the additive manufacturing apparatus according to the third embodiment.

FIG. 35 is a diagram for explaining detection of the deflection width of the wire from the molten pool image captured by the camera of the additive manufacturing apparatus according to the third embodiment.

FIG. 36 is a diagram illustrating an exemplary configuration of the control circuit according to the first to third embodiments.

FIG. 37 is a diagram illustrating an exemplary configuration of a dedicated hardware circuit according to the first to third embodiments.

### DESCRIPTION OF EMBODIMENTS

Hereinafter, a defect estimation device, a numerical control device, an additive manufacturing apparatus, and a defect estimation method according to embodiments will be described in detail with reference to the drawings.

### First Embodiment

Internal defects can result from a variety of factors. In particular, in the case of additive manufacturing using a wire as a material, in a type of DED additive manufacturing, a stub phenomenon in which the distal end portion of the wire collides with the workpiece in an unmelted state may occur during shaping, which can cause an internal defect. Alternatively, an internal defect may occur due to a wire rubbing phenomenon in which an unmelted wire rubs against an unsolidified bead outside the irradiation range of the beam and a streaky trace remains on the bead. Alternatively, when a plurality of beads are arranged in parallel, a bead gap phenomenon may occur in which a gap is generated between beads adjacent to each other due to the bead width being narrower than expected, which can cause an internal defect. In the first embodiment, an example will be described in which the presence or absence of at least one of the stub phenomenon, the wire rubbing phenomenon, and the bead gap phenomenon is determined in DED additive manufacturing, and the state of an internal defect is estimated based on the determination result.

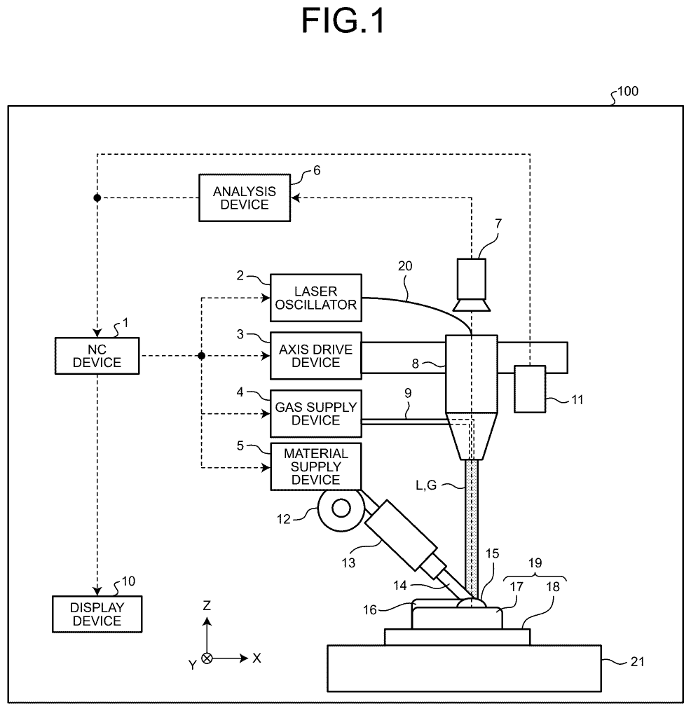

FIG. 1 is a diagram illustrating an exemplary configuration of an additive manufacturing apparatus 100 according to the first embodiment. The additive manufacturing apparatus 100 is a DED-type additive manufacturing apparatus. The additive manufacturing apparatus 100 manufactures an object 17 by supplying a material to a workpiece 19 and stacking beads 16 formed of the material melted using a beam. The beam is a heat source that melts the material, and is a laser beam L, an electron beam, or the like. In the first embodiment, a case where the beam is the laser beam L will be described as an example. In the first embodiment, the material is a metal wire 14.

The additive manufacturing apparatus 100 forms the bead 16 by irradiating the wire 14 and the workpiece 19 with the laser beam L while supplying the wire 14 to a specified position. A layer of beads 16 is formed by arranging a plurality of beads 16 on a base material 18. By stacking layers of beads 16, the object 17, which is a deposit of the beads 16, is formed. Thus, the additive manufacturing apparatus 100 manufactures the object 17, which is a three-dimensional object, by stacking the beads 16. The base material 18 illustrated in FIG. 1 is a plate material. The base material 18 may be a material other than a plate material. The workpiece 19 is a thing to which a melted material is added, and includes the base material 18 and the object 17 being shaped. The object 17 is formed on the base material 18.

The X axis, the Y axis, and the Z axis are three axes perpendicular to each other. The X axis and the Y axis are two horizontal axes. The Z axis is a vertical axis. In each of the X-axis direction, the Y-axis direction, and the Z-axis direction, a direction indicated by an arrow is plus, and a direction opposite to the arrow is minus. The plus Z direction is assumed to be a vertically upper direction. The beads 16 are stacked in the plus Z direction.

The additive manufacturing apparatus 100 includes a numerical control (NC) device 1, a laser oscillator 2, an axis drive device 3, a gas supply device 4, a material supply device 5, an analysis device 6, a camera 7, a machining head 8, and a stage 21. The base material 18 is fixed to the stage 21. The laser oscillator 2, the axis drive device 3, the gas supply device 4, the material supply device 5, the machining head 8, and the stage 21 constitute a shaping unit that manufactures the object 17 by supplying material to the workpiece 19 and stacking the beads 16 formed of the material melted using the laser beam L.

The laser oscillator 2 that is a beam source outputs the laser beam L. The laser oscillator 2 is an example of a heat source generation device that generates a heat source. The laser beam L output from the laser oscillator 2 propagates through a fiber cable 20 which is an optical transmission line, and enters the machining head 8. An optical system such as a collimating optical system or a condensing optical system is disposed inside the machining head 8. The optical system is not illustrated. The laser oscillator 2, the fiber cable 20, and the machining head 8 constitute an irradiation unit that irradiates the workpiece 19 with the laser beam L.

The machining head 8 is equipped with a beam nozzle through which the laser beam L emitted from the machining head 8 toward a machining point passes, and a gas nozzle 9 that ejects a shielding gas G toward the machining point. The central axis of the beam nozzle coincides with the optical axis of the optical system. The central axis of the beam nozzle also coincides with the Z axis. That is, the central axis of the laser beam L with which the workpiece 19 is irradiated coincides with the Z axis. The laser beam L passes through the optical system inside the machining head 8, passes through the beam nozzle, and is emitted from the machining head 8. The machining point is the irradiation position of the laser beam L on the workpiece 19, and is a region to which the wire 14 is added. The additive manufacturing apparatus 100 moves the machining point along the movement path during the additive machining of adding the molten material.

The gas supply device 4 supplies the shielding gas G from a gas supply source to the gas nozzle 9. An example of the gas supply source is a gas cylinder. The gas supply source is connected to the gas nozzle 9 via a pipe. The gas supply source and the pipe are not illustrated. The gas supply device 4 can change the flow rate of the shielding gas G based on a gas supply command from the NC device 1. By ejecting the shielding gas G, oxidation is reduced near the machining point, and the object 17 is cooled. The shielding gas G is desirably an inert gas such as argon gas.

The material supply device 5 supplies the wire 14 toward the machining point. The material supply device 5 includes a material supply source 12 and a material supply nozzle 13. The material supply device 5 supplies the wire 14 fed from the material supply source 12 to the machining point by the material supply nozzle 13. FIG. 1 illustrates an example of a side supply method of supplying the wire 14 from the material supply nozzle 13 disposed obliquely above the machining point. Instead of the side supply method, the material supply device 5 may use a center supply method of supplying the wire 14 from the material supply nozzle 13 disposed immediately above the machining point. The material supply device 5 is operated by a servomotor, and can change the supply speed of the wire 14 based on a material supply command from the NC device 1.

The axis drive device 3 moves the machining head 8, the material supply device 5, and a height measurement instrument 11 in the X-axis direction, the Y-axis direction, and the Z-axis direction based on a movement speed command from the NC device 1. The positional relationship among the machining head 8, the material supply device 5, and the height measurement instrument 11 is fixed. An example of the axis drive device 3 is a servomotor that moves the machining head 8, the material supply device 5, and the height measurement instrument 11 in the X-axis direction, a servomotor that moves the machining head 8, the material supply device 5, and the height measurement instrument 11 in the Y-axis direction, and a servomotor that moves the machining head 8, the material supply device 5, and the height measurement instrument 11 in the Z-axis direction. The servomotors are not illustrated. The additive manufacturing apparatus 100 can move the irradiation position of the laser beam L, the supply position of the wire 14, and the measurement position by the height measurement instrument 11 to any positions within the stroke range of the machining head 8, the material supply device 5, and the height measurement instrument 11 by operating each servomotor.

The camera 7 is an imaging device that captures an image of a region including the machining point on the workpiece 19 from vertically above. As an example, the camera 7 acquires an image of a region including the machining point, and outputs the acquired image to the analysis device 6.

The analysis device 6 detects a bead width which is the width of the bead 16 formed in the molten pool 15 by analyzing an image input from the camera 7. That is, the analysis device 6 detects the bead width of the bead 16 during the shaping. The analysis device 6 outputs the detection result of the bead width to the NC device 1. The molten pool 15 is a pool of molten metal formed by melting the workpiece 19 and the wire 14 by irradiation with the laser beam L.

The height measurement instrument 11 measures a height that is a distance from the reference position in the Z-axis direction. The height measurement instrument 11 is installed at a position movable in the X-axis direction, the Y-axis direction, and the Z-axis direction by the axis drive device 3. As an example, the height measurement instrument 11 is a laser displacement sensor. The height measurement instrument 11 outputs a measurement result of the height to the NC device 1.

The NC device 1 is a control device that controls the entire additive manufacturing apparatus 100. The NC device 1 controls the additive manufacturing apparatus 100 according to a machining program 23 and machining conditions 22. In the machining program 23, a movement command for moving the machining head 8 and the material supply device 5 in a preset path is described. The machining conditions 22 include information necessary for forming the bead 16, such as laser output, which is the output of the laser beam L by the laser oscillator 2, movement speed, which is the speed for moving the irradiation position of the laser beam L and the supply position of the wire 14, material supply speed, which is the speed for supplying the wire 14 by the material supply device 5, and gas flow rate, which is the flow rate of the shielding gas G.

The NC device 1 controls the axis drive device 3 according to the machining program 23. The axis drive device 3 moves the machining head 8 and the material supply device 5 along a preset movement path under the control of the NC device 1. The NC device 1 may correct the position of the movement path in the Z-axis direction such that the movement path follows the undulations of the upper surface of the workpiece 19 based on the result of measuring the height of the upper surface of the workpiece 19 by the height measurement instrument 11. The upper surface of the workpiece 19 is a machining surface of the workpiece 19 on which the bead 16 is formed.

The NC device 1 controls the laser oscillator 2 by outputting a laser output command to the laser oscillator 2 according to the machining conditions 22. The laser oscillator 2 outputs the laser beam L according to the laser output command. The NC device 1 controls the material supply device 5 by outputting a material supply command to the material supply device 5 according to the machining conditions 22. The material supply device 5 supplies the wire 14 at the material supply speed according to the material supply command. The NC device 1 outputs a movement speed command to the axis drive device 3 according to the machining conditions 22. The axis drive device 3 moves the irradiation position of the laser beam L and the supply position of the wire 14 at a movement speed according to the movement speed command. The NC device 1 controls the gas supply device 4 by outputting a gas supply command to the gas supply device 4 according to the machining conditions 22. The gas supply device 4 supplies the shielding gas G at a gas flow rate according to the gas supply command.

In the first embodiment, the NC device 1 functions as a defect estimation device that estimates the state of an internal defect that is a gap formed inside the object 17. Note that the NC device 1 illustrated in FIG. 1 is included in the additive manufacturing apparatus 100. That is, the NC device 1 is a component of the additive manufacturing apparatus 100. The NC device 1 may be a device outside the additive manufacturing apparatus 100.

A display device 10 displays information on the internal defect on a screen. The display device 10 is a liquid crystal display, an organic electroluminescence (EL) display, or the like. The display device 10 may also display an operation screen for operating the additive manufacturing apparatus 100. As the display device 10, a display provided in a computer system outside the additive manufacturing apparatus 100 may be used.

Next, an outline of the operation of the additive manufacturing apparatus 100 will be described. After the base material 18 is fixed on the stage 21, the additive manufacturing apparatus 100 operates the laser oscillator 2, the axis drive device 3, the gas supply device 4, and the material supply device 5 under the control of the NC device 1. The additive manufacturing apparatus 100 operates the laser oscillator 2 to irradiate the machining point with the laser beam L. The additive manufacturing apparatus 100 supplies the wire 14 to the machining point by operating the material supply device 5. The additive manufacturing apparatus 100 ejects the shielding gas G to the machining point by operating the gas supply device 4. The additive manufacturing apparatus 100 moves the machining point on the movement path by operating the axis drive device 3.

The molten pool 15 is formed on the workpiece 19 by irradiation with the laser beam L. The bead 16 is formed by movement of the machining point along with formation of the molten pool 15. The object 17 is formed by stacking the solidified beads 16. The additive manufacturing apparatus 100 may measure the height of the upper surface of the workpiece 19 by the height measurement instrument 11 before forming the bead 16, and may correct the movement path specified by the machining program 23 in accordance with the height of the upper surface of the workpiece 19.

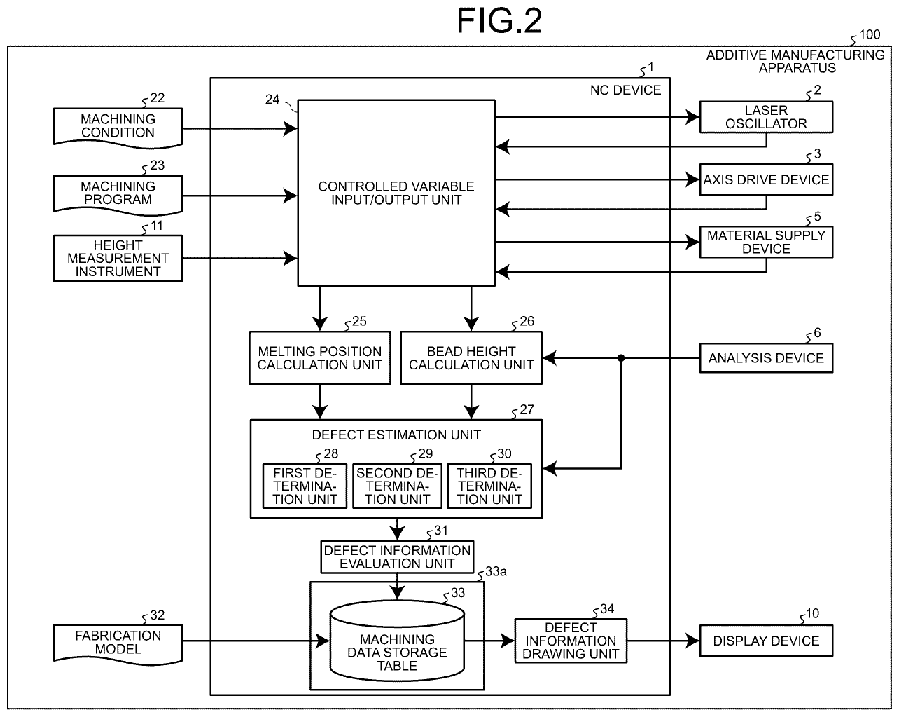

Next, a function of the NC device 1 will be described. FIG. 2 is a diagram illustrating an exemplary functional configuration of the NC device 1 provided in the additive manufacturing apparatus 100 according to the first embodiment. The machining conditions 22 are input to the NC device 1, whereby each piece of information of the laser output, the movement speed, the material supply speed, and the gas flow rate is given to the NC device 1. The machining program 23 is input to the NC device 1, whereby the NC device 1 is informed of the movement path.

The NC device 1 includes a controlled variable input/output unit 24, a melting position calculation unit 25, a bead height calculation unit 26, a defect estimation unit 27, a defect information evaluation unit 31, a defect information storage unit 33a, and a defect information drawing unit 34. The defect information storage unit 33a holds a machining data storage table 33.

The machining conditions 22 and the machining program 23 are input to the controlled variable input/output unit 24. A result of measuring the height of the upper surface of the workpiece 19 by the height measurement instrument 11 is input to the controlled variable input/output unit 24. The controlled variable input/output unit 24 may correct the movement path specified by the machining program 23 according to the height of the upper surface of the workpiece 19. The controlled variable input/output unit 24 generates a laser output command, a movement speed command, a material supply command, and a gas supply command based on the input machining conditions 22 and the input machining program 23.

The controlled variable input/output unit 24 outputs a laser output command to the laser oscillator 2. The controlled variable input/output unit 24 outputs a movement speed command to the axis drive device 3. The controlled variable input/output unit 24 outputs a material supply command to the material supply device 5. The controlled variable input/output unit 24 outputs a gas supply command to the gas supply device 4. In FIG. 2, the gas supply device 4 is not illustrated. Each of the laser output, the movement speed, and the material supply speed may vary due to control during shaping.

The controlled variable input/output unit 24 acquires the feedback value of the laser output from the laser oscillator 2. The controlled variable input/output unit 24 acquires the feedback value of the movement speed and the feedback value of the movement path from the axis drive device 3. The controlled variable input/output unit 24 acquires the feedback value of the material supply speed from the material supply device 5. As described above, the controlled variable input/output unit 24 acquires these feedback values that are results of actual operation of the additive manufacturing apparatus 100 according to each command. The controlled variable input/output unit 24 outputs the acquired feedback value to the melting position calculation unit 25 and the bead height calculation unit 26.

The feedback value output from the controlled variable input/output unit 24 is used in the calculation of the wire melting position in the melting position calculation unit 25 and the calculation of the bead height in the bead height calculation unit 26. The wire melting position is a position where the temperature of the wire 14 reaches the melting point of the wire 14. In other words, the wire melting position is the distal end position of a portion of the wire 14 where a state change from solid to liquid occurs. In the following description, the wire melting position may be simply referred to as the melting position. The bead height is the height of the bead 16 in the Z-axis direction in which the beads 16 are stacked.

The melting position calculation unit 25 calculates the wire melting position based on the material supply speed and the laser output. Feedback values of the laser output, the material supply speed, and the movement path are input to the melting position calculation unit 25. The melting position calculation unit 25 calculates the wire melting position based on the respective feedback values of the laser output, the material supply speed, and the movement path; physical property values of the wire 14; and machine parameters of the additive manufacturing apparatus 100. Here, the physical property values are various physical property values related to melting of the wire 14, such as the melting point, the absorptivity of the laser beam L, the heat capacity, or the thermal conductivity. The machine parameters are geometric information such as the wire supply angle or the laser beam diameter. The wire supply angle is the angle between the traveling direction of the wire 14 supplied to the workpiece 19 and the X axis. The laser beam diameter is the diameter of the laser beam L incident on the workpiece 19. The melting position calculation unit 25 outputs the calculation result of the wire melting position to the defect estimation unit 27.

Feedback values of the material supply speed, the movement speed, and the movement path, and a detection result of the bead width by the analysis device 6 are input to the bead height calculation unit 26. The bead height calculation unit 26 calculates the bead height of the bead 16 during the shaping based on the respective feedback values of the material supply speed, the movement speed, and the movement path and the bead width of the bead 16 during the shaping. Note that the bead height calculation unit 26 may calculate the bead height based on the feedback values of the material supply speed, the movement speed, and the movement path and the laser beam diameter assuming that the laser beam diameter is the same as the bead width. The bead height calculation unit 26 outputs the calculation result of the bead height to the defect estimation unit 27.

The defect estimation unit 27 determines the presence or absence of a first phenomenon, a second phenomenon, and a third phenomenon, and obtains defect information indicating the state of an internal defect based on the determination result. The first phenomenon is a phenomenon in which an unmelted material collides with the workpiece 19, namely the stub phenomenon described above. The second phenomenon is a phenomenon in which an unmelted material is rubbed against the bead 16 to generate a trace on the bead 16, namely the wire rubbing phenomenon described above. The third phenomenon is a phenomenon in which a gap is generated between the beads 16 adjacent to each other, namely the bead gap phenomenon described above. The defect information includes at least one of the presence or absence of an internal defect, the number of internal defects, the length of the internal defect, and the size of the internal defect. The length of the internal defect is a length in the traveling direction which is the direction of the movement path on which the bead 16 is formed. The size of the internal defect is the area of the internal defect on a plane perpendicular to the traveling direction.

The defect estimation unit 27 receives the calculation result of the wire melting position, the calculation result of the beat height, and the detection result of the bead width by the analysis device 6. The defect estimation unit 27 includes a first determination unit 28, a second determination unit 29, and a third determination unit 30.

The first determination unit 28 determines the presence or absence of the stub phenomenon based on the melting position calculated by the melting position calculation unit 25. In response to determining that the stub phenomenon has occurred, the first determination unit 28 calculates defect information on an internal defect caused by the stub phenomenon. In response to determining that the stub phenomenon has occurred, the first determination unit 28 calculates first defect information including at least one of the number of internal defects, the size of the internal defect, and the length of the internal defect based on the duration of the stub phenomenon, the number of occurrences of the stub phenomenon, and the collision depth of the wire 14 with the workpiece 19. The first determination unit 28 outputs the calculated first defect information to the defect information evaluation unit 31.

The second determination unit 29 determines the presence or absence of the wire rubbing phenomenon based on the bead height calculated by the bead height calculation unit 26. In response to determining that the wire rubbing phenomenon has occurred, the second determination unit 29 calculates defect information on an internal defect caused by the wire rubbing phenomenon. In response to determining that the wire rubbing phenomenon has occurred, the second determination unit 29 calculates second defect information including at least one of the number of internal defects, the size of the internal defect, and the length of the internal defect based on the duration of the wire rubbing phenomenon, the number of occurrences of the wire rubbing phenomenon, and the interference depth of the wire 14 with the bead 16. The second determination unit 29 outputs the calculated second defect information to the defect information evaluation unit 31. Note that in a case where the upper surface of the workpiece 19 is inclined with respect to the XY plane, the second determination unit 29 determines the presence or absence of the wire rubbing phenomenon by consideration of the inclination of the upper surface of the workpiece 19.

The third determination unit 30 determines the presence or absence of the bead gap phenomenon based on the movement path and the bead width. In response to determining that the bead gap phenomenon has occurred, the third determination unit 30 calculates defect information on an internal defect caused by the bead gap phenomenon. In response to determining that the bead gap phenomenon has occurred, the third determination unit 30 calculates third defect information including at least one of the number of internal defects, the size of the internal defect, and the length of the internal defect based on the duration of the bead gap phenomenon, the number of occurrences of the bead gap phenomenon, and the width of the gap. The third determination unit 30 outputs the calculated third defect information to the defect information evaluation unit 31.

The defect information evaluation unit 31 writes the defect information calculated by the defect estimation unit 27, that is, at least one of the first defect information, the second defect information, and the third defect information, in the machining data storage table 33. As the defect information is written in the machining data storage table 33, the defect information is stored in the defect information storage unit 33a. Since the defect information is stored, the state of the internal defect included in the entire object 17 can be grasped after the shaping.

The defect information evaluation unit 31 evaluates the internal defect by obtaining, based on the defect information, a defect influence degree that numerically represents the magnitude of the influence of the internal defect on the quality of the object 17. The defect information evaluation unit 31 calculates the defect influence degree for each position of object 17 based on at least one of the first defect information calculated by the first determination unit 28, the second defect information calculated by the second determination unit 29, and the third defect information calculated by the third determination unit 30. The calculated defect influence degree data is stored in the machining data storage table 33 in association with position information and time information. The position information is information indicating a position on the object 17. The time information is information indicating the time when the shaping was performed.

Further, a fabrication model 32, a molten pool image, the machining program 23, the machining conditions 22, and the various feedback values acquired by the controlled variable input/output unit 24 are stored in the machining data storage table 33 in association with the position information and the time information. The user of the additive manufacturing apparatus 100 can refer to the various types of information stored in the machining data storage table 33 after machining. Since these various types of information are associated with the position information and the time information, it is possible to use these various types of information as traceability by comparison with data regarding the position where the internal defect has occurred in the object 17. The fabrication model 32 illustrated in FIG. 2 is input to the NC device 1 separately from the machining program 23. The NC device 1 may generate information corresponding to the fabrication model 32 based on the machining program 23 or the machining conditions 22, and use the generated information instead of the fabrication model 32.

The defect information drawing unit 34 reads the data of the defect influence degree from the machining data storage table 33. The defect information drawing unit 34 generates an image visually representing the distribution of the values stored in the defect information storage unit 33a by the model of the object 17. The defect information drawing unit 34 visualizes the evaluation result of the quality of the object 17 by adding the data of the defect influence degree to the fabrication model 32. Adding the data of the defect influence degree means, for example, adding a color representing the range of values of the defect influence degree to the fabrication model 32. The defect information drawing unit 34 outputs the generated image to the display device 10. The user can visually check the quality of the object 17 from the image displayed on the display device 10. The data added to the fabrication model 32 is not limited to the data of the defect influence degree. The defect information drawing unit 34 may add any information stored in the machining data storage table 33 to the fabrication model 32.

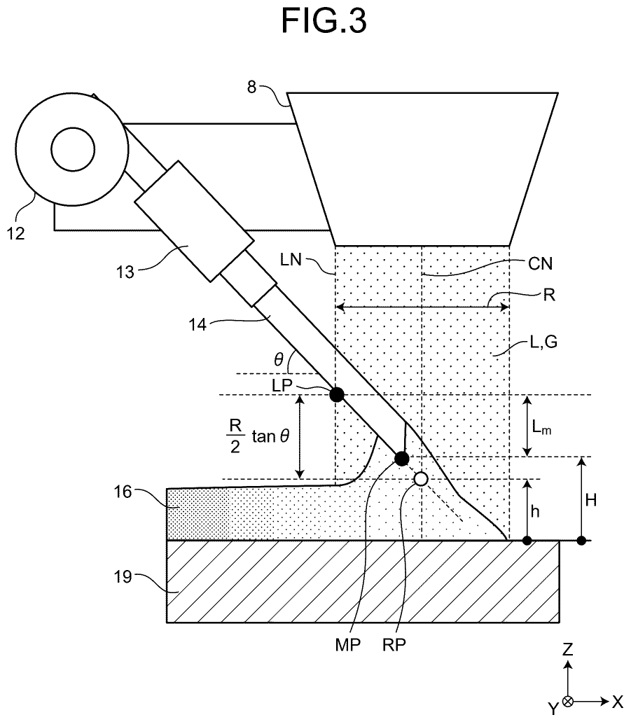

Next, a method of calculating the wire melting position by the melting position calculation unit 25 will be described. FIG. 3 is a diagram for explaining formation of the object 17 by the additive manufacturing apparatus 100 according to the first embodiment. FIG. 3 schematically illustrates formation of the bead 16 on the workpiece 19.

Reference character “θ” is an angle formed by the traveling direction of the wire 14 from the material supply nozzle 13 toward the workpiece 19 and the X axis which is an axis perpendicular to the center line CN of the laser beam L. Reference character “θ” represents the direction of the wire 14 supplied to the workpiece 19. Reference character “R” is the laser beam diameter of the laser beam L in a plane perpendicular to the center line CN. The distal end position MP of the wire 14 is a position of the wire 14 where the temperature reaches the melting point of the wire 14 by irradiation with the laser beam L.

The intersection of the center line CN of the laser beam L and the traveling direction of the wire 14 is referred to as a machining reference point RP. In the case of shaping by a normal program command, shaping is started from a position where the machining reference point RP coincides with the upper surface of the workpiece 19. The intersection of the boundary line LN on the side of the laser beam L where the wire 14 enters and the traveling direction of the wire 14 is referred to as a wire inrush point LP.

Reference character “h” is a distance in the Z-axis direction from the upper surface of the workpiece 19 to the machining reference point RP, and is the offset distance of the machining head 8. The additive manufacturing apparatus 100 can change “h” before or during machining.

Reference character “H” is a distance in the Z-axis direction from the upper surface of the workpiece 19 to the distal end position MP. That is, “H” is the distance between the position of the wire 14 where the state change from solid to liquid occurs and the upper surface of the workpiece 19, and is the distance between the wire melting position and the machining surface.

Reference character “Lₘ” is a distance in the Z-axis direction between the wire inrush point LP and the distal end position MP. Reference character “Lₘ” can also be said to be the distance by which the wire 14 moves from when the wire 14 enters the irradiation range of the laser beam L to when the wire 14 reaches the melting point. Calculating the wire melting position by the melting position calculation unit 25 refers to calculating “Lₘ”, which is a distance representing the wire melting position.

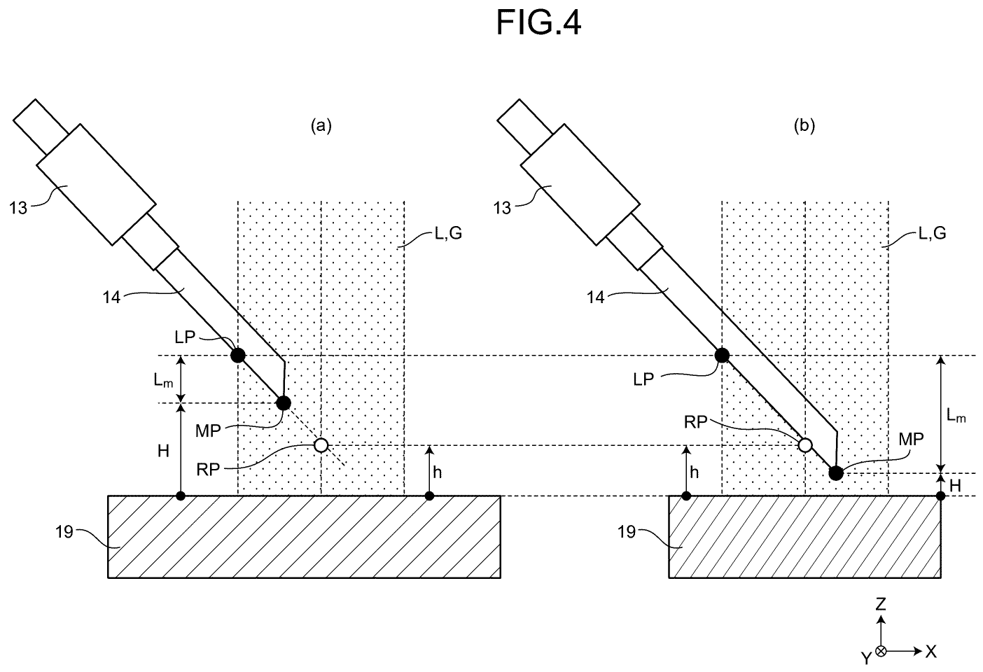

FIG. 4 is a diagram for explaining calculation of the wire melting position according to the first embodiment. FIG. 4 illustrates “Lₘ” in two cases where the laser output or the material supply speed is different from each other. Case (a) illustrated in FIG. 4 is a case where the laser output is high or the material supply speed is low as compared with case (b) illustrated in FIG. 4. In case (a), the temperature of the wire 14 reaches the melting point earlier than in case (b). Therefore, “Lₘ” in case (a) is shorter than “Lₘ” in case (b). As described above, the distal end position MP changes depending on the machining conditions, and “Lₘ” also changes. As “Lₘ” changes, “H” also changes.

Here, suppose that heat other than the heat absorbed by the laser beam L in the heat input to the wire 14 is sufficiently smaller than the absorbed heat. That is, heat conduction from the workpiece 19 to the wire 14 is ignored, and the temperature of the wire 14 in the laser beam L is determined only by irradiation with the laser beam L.

Here, “Lₘ” is expressed by Formula (1) below.

Lₘ=K×(F_{WC}/P_{c}) (1)

Reference character “F_{WC}” is a feedback value of the material supply speed. Reference character “P_{C}” is a feedback value of the laser output. Reference character “K” is a constant that summarizes the physical property values of the wire 14 and sinθ, which is a machine parameter of the additive manufacturing apparatus 100. The command value of the material supply speed and the command value of the laser output are included in the machining conditions 22.

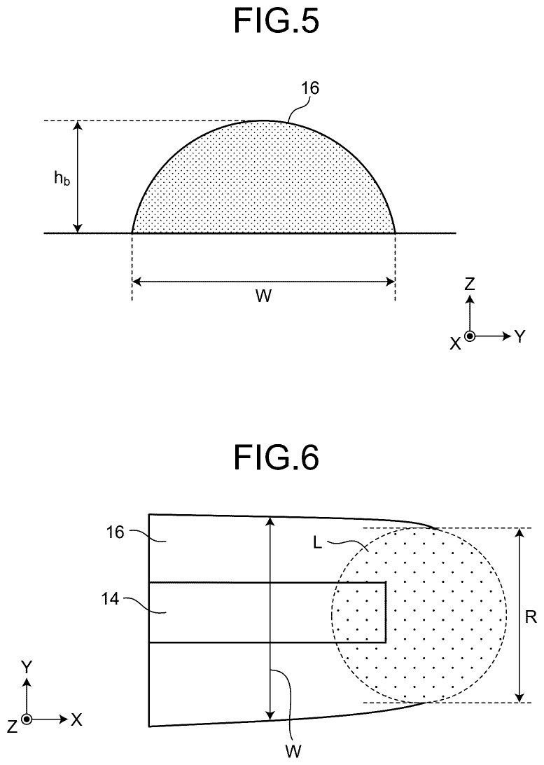

Next, a method of calculating the bead height by the bead height calculation unit 26 will be described. FIG. 5 is a diagram for explaining calculation of the bead height according to the first embodiment. FIG. 5 illustrates a YZ cross section of the bead 16. The bead height calculation unit 26 estimates “h_{b}”, which is the beat height, based on the cross-sectional area of the bead 16, the cross-sectional shape of the bead 16, and the bead width W. The cross-sectional area of the bead 16 is the area of the YZ cross section of the bead 16. The cross-sectional shape is the shape of the YZ cross section of the bead 16.

The bead height calculation unit 26 calculates “h_{b}” based on the volume of the bead 16 per unit length in the traveling direction. The bead height calculation unit 26 may calculate “h_{b}” based on the material supply speed, the movement speed of the laser beam L in the workpiece 19, and the width of the bead 16. The bead height calculation unit 26 may regard a result obtained by dividing the material supply speed by the movement speed as the cross-sectional area. Assuming that the cross-sectional shape is a portion including an arc of a circle, the bead width W is a width in a direction perpendicular to the stacking direction and the traveling direction. Note that the bead height calculation unit 26 may estimate the bead height by a method other than the method described in the first embodiment 1.

FIG. 6 is a schematic diagram of a molten pool image used for calculating the bead width W in the first embodiment. The molten pool image is an image obtained by capturing the bead 16 being shaped from immediately above in the Z-axis direction. The analysis device 6 calculates the bead width W of the bead 16 being shaped from the molten pool image captured by the camera 7. The bead height calculation unit 26 may calculate “h_{b}” using “R” that is the diameter of the laser beam L instead of the bead width W. The bead height calculation unit 26 can calculate “h_{b}” by using a geometric relationship of circles.

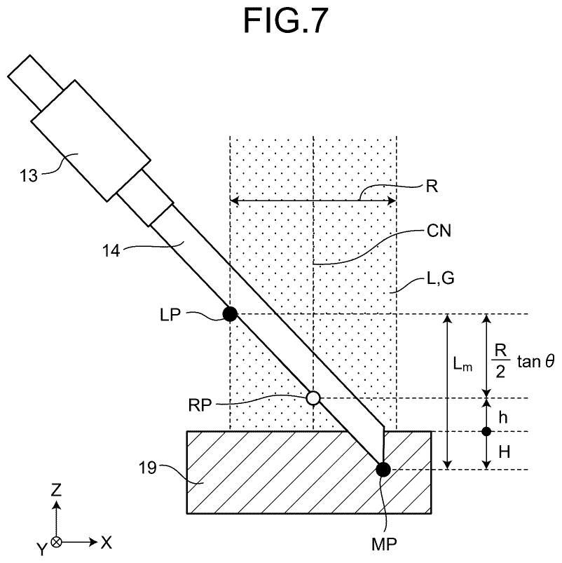

Next, determination of the presence or absence of the stub phenomenon and calculation of defect information on the internal defect caused by the stub phenomenon will be described. FIG. 7 is a diagram for explaining occurrence of the stub phenomenon in the additive manufacturing apparatus 100 according to the first embodiment. The first determination unit 28 determines the presence or absence of the stub phenomenon based on the positional relationship between the calculated melting position and the machining surface of the workpiece 19 on which the bead 16 is formed.

In FIG. 7, it is assumed that the distal end position MP is below the upper surface of the workpiece 19. If the depth of the molten pool in the workpiece 19 is not taken into consideration, the presence or absence of the stub phenomenon can be determined from the value of “H”. “H” can be obtained from the positional relationship illustrated in FIG. 3. “H” is expressed by Formula (2) below using “Lₘ” calculated by Formula (1).

H=h+(R/2)·tanθ−Lₘ (2)

When “H” is a positive value, the stub phenomenon does not occur because the state change of the wire 14 from solid to liquid occurs above the upper surface of the workpiece 19. When “H” is a negative value, as illustrated in FIG. 7, the state change of the wire 14 from solid to liquid occurs below the upper surface of the workpiece 19. In actual shaping, since the distal end position MP does not go below the upper surface of the workpiece 19, the stub phenomenon occurs in which the wire 14 collides with the workpiece 19. When determining that the stub phenomenon has occurred, the first determination unit 28 determines that an internal defect has occurred. The absolute value of “H” given that “H” is a negative value represents the collision depth of the wire 14 with the workpiece 19. The larger the absolute value of “H” that is a negative value, the more strongly the wire 14 collides with the workpiece 19. Thus, the first determination unit 28 determines the presence or absence of the stub phenomenon based on the positional relationship between the wire melting position and the machining surface of the workpiece 19 on which the bead 16 is formed.

The first determination unit 28 obtains defect information on the internal defect caused by the occurrence of the stub phenomenon based on at least one of the number of times of occurrence of the stub phenomenon, the duration of the stub phenomenon, and the distance between the wire melting position and the machining surface.

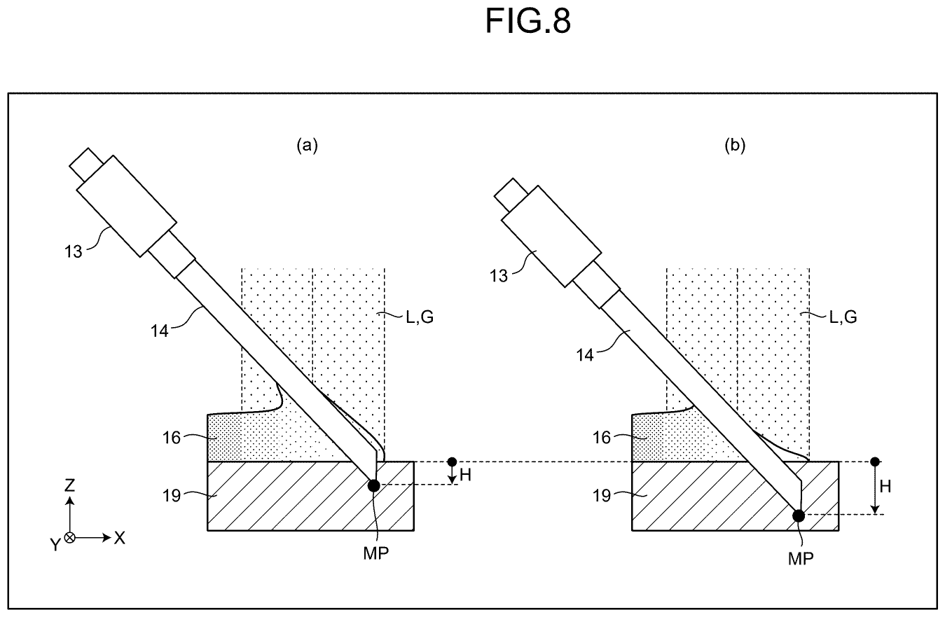

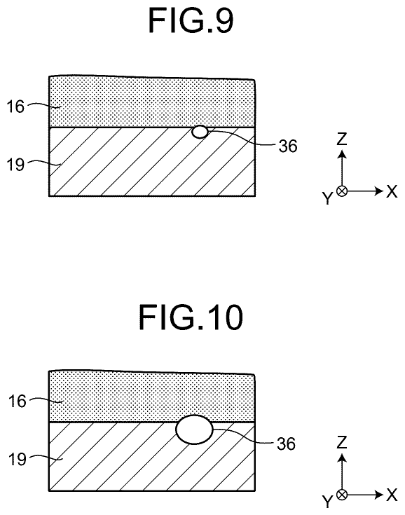

FIG. 8 is a first diagram for explaining the relationship between the state of the stub phenomenon occurring in the additive manufacturing apparatus 100 according to the first embodiment and the internal defect. FIG. 9 is a diagram illustrating an example of an internal defect occurring in case (a) illustrated in FIG. 8. FIG. 10 is a diagram illustrating an example of an internal defect occurring in case (b) illustrated in FIG. 8. In each of cases (a) and (b) illustrated in FIG. 8, “H” is a negative value, and the stub phenomenon occurs. In case (b), the absolute value of “H” is larger than that in case (a). The size of the internal defect 36 illustrated in FIG. 10 is larger than the size of the internal defect 36 illustrated in FIG. 9. The first determination unit 28 can estimate the size of the internal defect 36 from the calculated value of “H”.

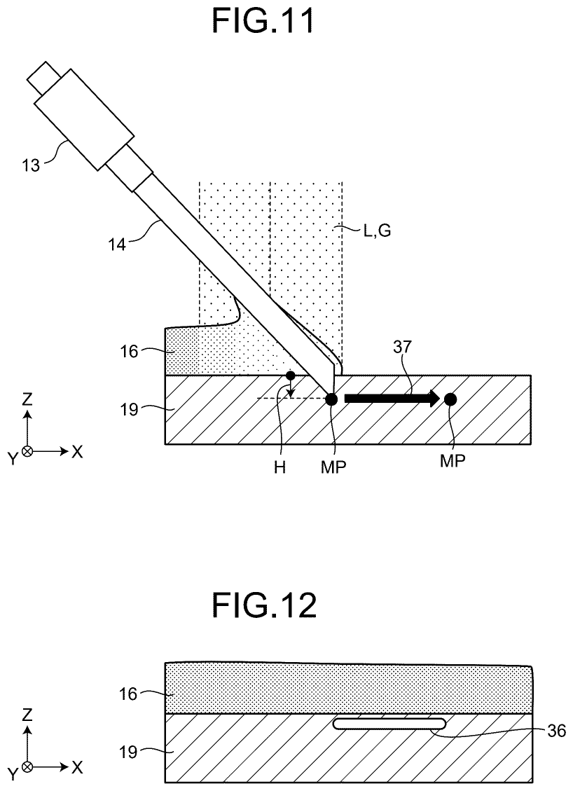

FIG. 11 is a second diagram for explaining the relationship between the state of the stub phenomenon occurring in the additive manufacturing apparatus 100 according to the first embodiment and the internal defect. FIG. 12 is a diagram illustrating an example of an internal defect occurring in case illustrated in FIG. 11. FIG. 11 illustrates a case where the shaping is continued while “H” remains a negative value. The occurrence of the continuous stub phenomenon in the section 37 results in formation of the internal defect 36 over the section 37. The first determination unit 28 can estimate the length of the internal defect 36 by obtaining the section 37 in which “H” is a negative value.

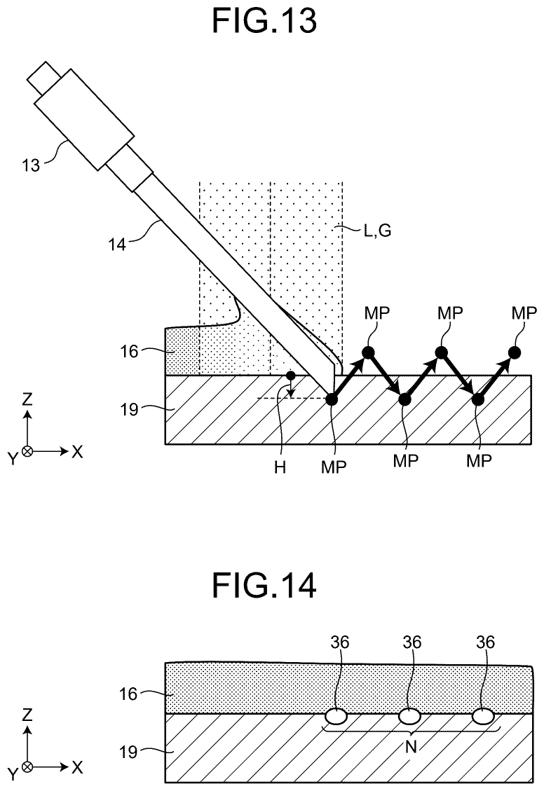

FIG. 13 is a third diagram for explaining the relationship between the state of the stub phenomenon occurring in the additive manufacturing apparatus 100 according to the first embodiment and the internal defect. FIG. 14 is a diagram illustrating an example of an internal defect occurring in the case illustrated in FIG. 13. FIG. 13 illustrates a case where “H” changes from a positive value to a negative value a plurality of times per unit distance. Each time “H” changes from a positive value to a negative value, the first determination unit 28 determines that the internal defect 36 has occurred. The first determination unit 28 can estimate the number N of internal defects 36 per unit distance by counting the number of times “H” changes from a positive value to a negative value.

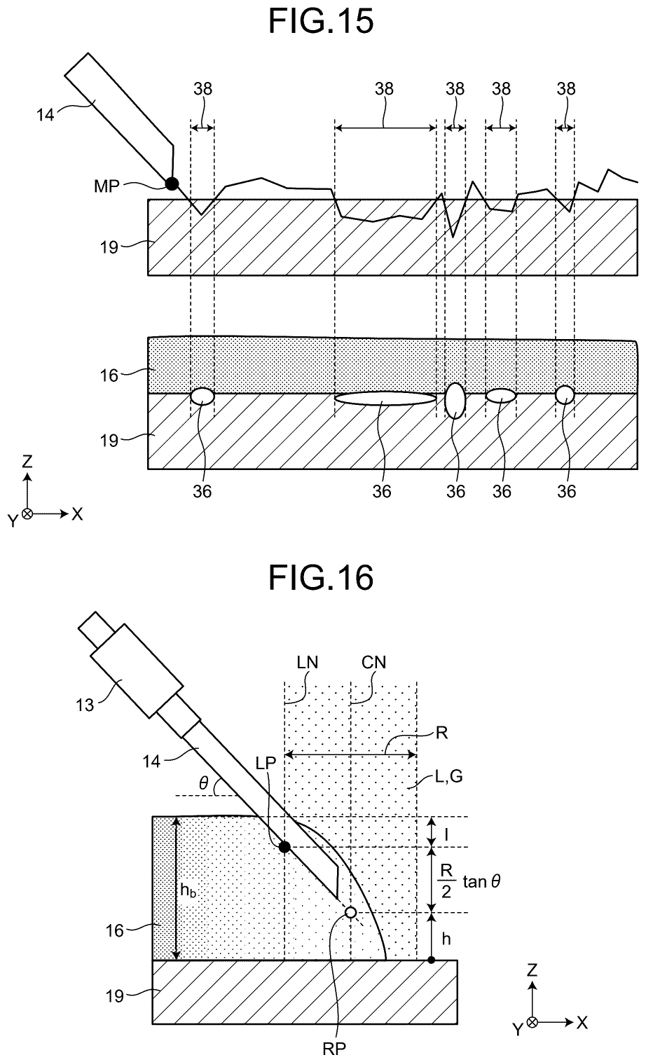

FIG. 15 is a fourth diagram for explaining the relationship between the state of the stub phenomenon occurring in the additive manufacturing apparatus 100 according to the first embodiment and the internal defect. FIG. 15 illustrates an example of the relationship between the trajectory of the distal end position MP at the time of shaping and the internal defect 36 generated by the stub phenomenon.

By plotting the distal end position MP on the basis of “H” calculated from various feedback values, it is possible to grasp which position in the Z-axis direction the distal end position MP is with respect to the upper surface of the workpiece 19. From the trajectory of the distal end position MP, it is possible to visually grasp that the internal defect 36 occurs in the section 38 in which the distal end position MP is lower than the upper surface of the workpiece 19, that is, “H” is a negative value. The first determination unit 28 can obtain defect information including at least one of the number of internal defects 36, the size of the internal defect 36, and the length of the internal defect 36 by analyzing the duration of the state in which the value of “H” is a negative value and the number of times “H” changes from a positive value to a negative value per unit distance. As a result, the first determination unit 28 estimates first defect information that is defect information including at least one piece of information of the number of internal defects 36, the length of the internal defect 36, and the size of the internal defect 36. Note that the first determination unit 28 may obtain the first defect information including information other than the number of internal defects 36, the size of the internal defect 36, or the length of the internal defect 36.

Next, determination of the presence or absence of the wire rubbing phenomenon and calculation of defect information on the internal defect caused by the wire rubbing phenomenon will be described. FIG. 16 is a diagram for explaining occurrence of the wire rubbing phenomenon in the additive manufacturing apparatus 100 according to the first embodiment. The second determination unit 29 determines the presence or absence of the wire rubbing phenomenon based on the relationship between the calculated bead height and the wire inrush point LP.

FIG. 16 illustrates a state in which the distal end portion of the wire 14 enters the unsolidified bead 16, that is, a state in which the wire 14 interferes with the bead 16. The second determination unit 29 can determine the presence or absence of the wire rubbing phenomenon based on “h_{b}” of the formed bead 16 and “h” that is the offset distance of the machining head 8.

From the geometric positional relationship between the wire 14 and the bead 16 as illustrated in FIG. 16, when the uppermost portion of the bead 16 is at a position higher than the wire inrush point LP, the wire 14 interferes with the bead 16 outside the irradiation range of the laser beam L. Therefore, when Formula (3) below is satisfied, the wire rubbing phenomenon occurs.

h_{b}>R/2·tanθ+h (3)

When Formula (3) holds, that is, when the wire rubbing phenomenon occurs, the interference distance I is expressed by Formula (4) below.

I=h_{b}−(R/2·tanθ+h) (4)

The interference distance I is a distance in the Z-axis direction between the upper surface of the bead 16 and the wire inrush point LP. The interference distance I expressed by Formula (4) is a difference obtained by subtracting the right side of Formula (3) from the left side of Formula (3). In this manner, the second determination unit 29 determines the presence or absence of the wire rubbing phenomenon based on the relationship between “h_{b}” and the wire inrush point LP.

The second determination unit 29 obtains defect information on the internal defect caused by the occurrence of the wire rubbing phenomenon based on at least one of the number of times of occurrence of the wire rubbing phenomenon, the duration of the wire rubbing phenomenon, and the distance between the machining surface and the wire inrush point LP.

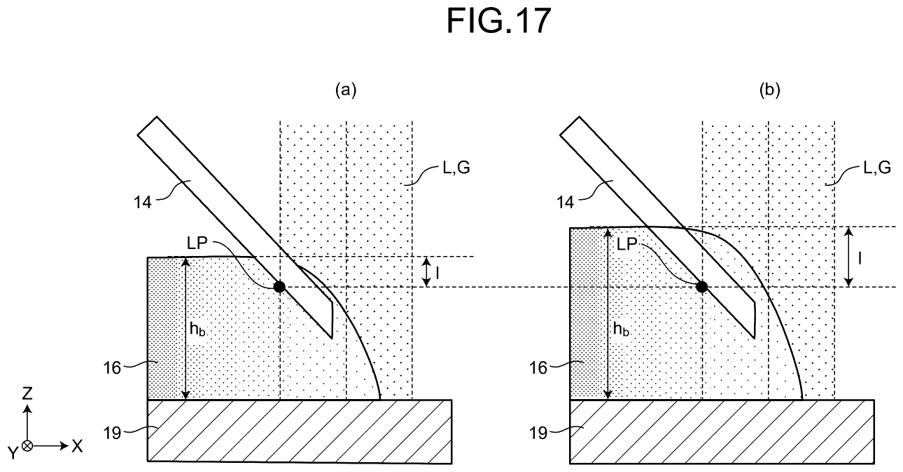

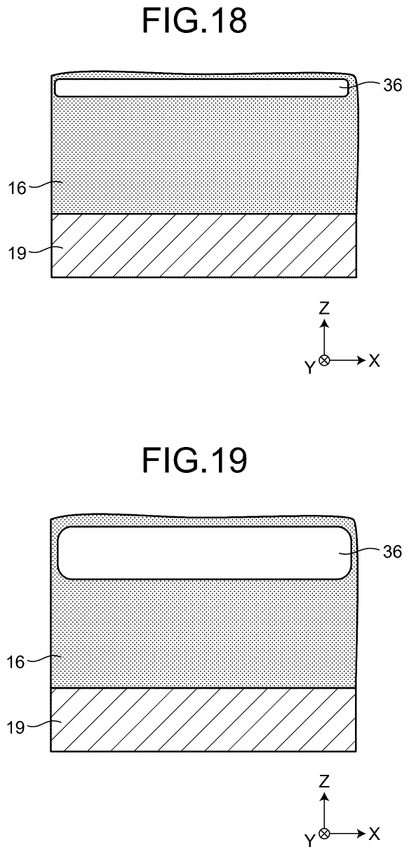

FIG. 17 is a fourth diagram for explaining the relationship between the wire rubbing phenomenon occurring in the additive manufacturing apparatus 100 according to the first embodiment and the internal defect. FIG. 18 is a diagram illustrating an example of an internal defect occurring in case (a) illustrated in FIG. 17. FIG. 19 is a diagram illustrating an example of an internal defect occurring in case (b) illustrated in FIG. 17. In each of cases (a) and (b) illustrated in FIG. 17, Formula (3) is satisfied, and the wire rubbing phenomenon occurs. In case (b), the interference distance I is longer than that in case (a). The longer the interference distance I, the deeper the wire 14 enters the bead 16.

The size of the internal defect 36 illustrated in FIG. 19 is larger than the size of the internal defect 36 illustrated in FIG. 18. The second determination unit 29 can estimate the size of the internal defect 36 from the calculated interference distance I. The second determination unit 29 can estimate the length of the internal defect 36 by obtaining the length of the section satisfying Formula (3). Furthermore, the second determination unit 29 can estimate the number of internal defects 36 per unit distance by counting the number of times of satisfying Formula (3).

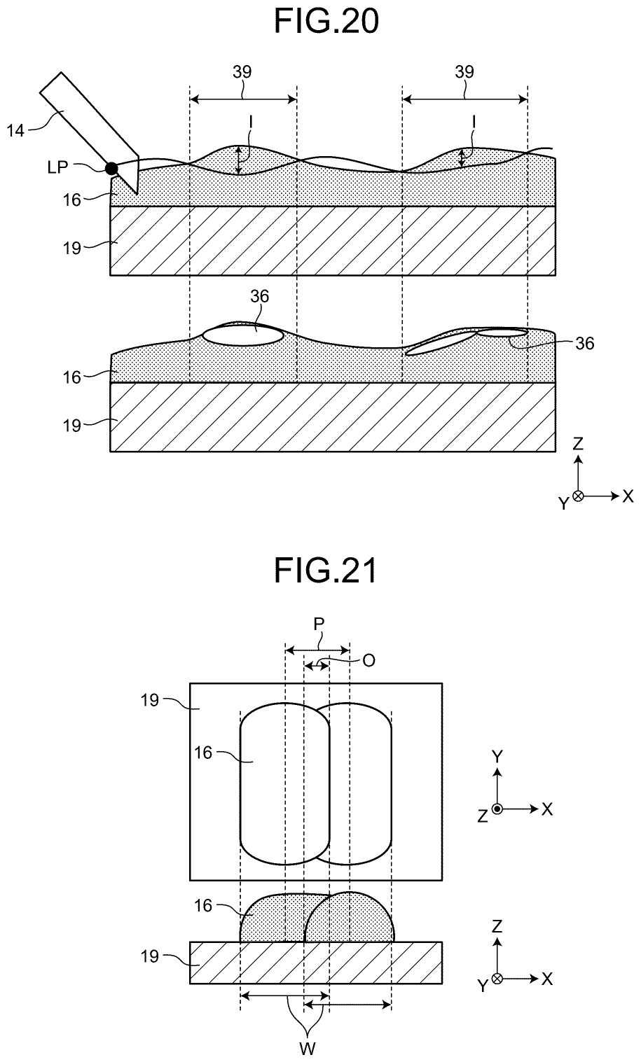

FIG. 20 is a second diagram for explaining the relationship between the wire rubbing phenomenon occurring in the additive manufacturing apparatus 100 according to the first embodiment and the internal defect. FIG. 20 illustrates an example of the relationship between the trajectory of the wire inrush point LP at the time of shaping and the internal defect 36 generated by the wire rubbing phenomenon.

By plotting the wire inrush point LP based on various feedback values and “h_{b}” and superimposing the shape of the formed bead 16 on the trajectory of the wire inrush point LP, it is possible to visually grasp that the internal defect 36 occurs in the section 39 satisfying Formula (3). In addition, the magnitude of the interference distance I in the section 39 can also be visually indicated. The second determination unit 29 can obtain defect information including the number of internal defects 36, the size of the internal defect 36, or the length of the internal defect 36 by analyzing the interference distance I, the section 39, and the number of times satisfying Formula (3) per unit distance from the plot of the wire inrush point LP. As a result, the second determination unit 29 estimates second defect information that is defect information including at least one piece of information of the number of internal defects 36, the length of the internal defect 36, and the size of the internal defect 36. Note that the second determination unit 29 may obtain the second defect information including information other than the number of internal defects 36, the size of the internal defect 36, or the length of the internal defect 36.

FIGS. 17 to 20 illustrate an example in which the presence or absence of the wire rubbing phenomenon is determined without considering the inclination of the upper surface of the workpiece 19. In a case where the upper surface of the workpiece 19 is inclined with respect to the XY plane, the second determination unit 29 determines the presence or absence of the wire rubbing phenomenon by consideration of the inclination of the upper surface of the workpiece 19.

Next, determination of the presence or absence of the bead gap phenomenon and calculation of defect information on the internal defect caused by the bead gap phenomenon will be described. FIG. 21 is a diagram for explaining occurrence of the bead gap phenomenon in the additive manufacturing apparatus 100 according to the first embodiment. FIG. 21 illustrates two beads 16 that are adjacent to each other in the X-axis direction and viewed from above, and a cross section of the two beads 16. The cross section illustrated in FIG. 21 is a cross section perpendicular to the Y axis which is the traveling direction at the time of forming each bead 16. The two beads 16 illustrated in FIG. 21 are formed on the machining surface of the workpiece 19.

The third determination unit 30 determines the presence or absence of the bead gap phenomenon based on the result of comparing the width of the bead 16 with a threshold calculated based on the pitch at which the beads 16 are arranged in parallel on the machining surface and the width of the portion where the beads 16 overlap each other.

After one of the two beads 16 is formed, the other of the two beads 16 is formed at a position separated from the one by a certain distance on the XY plane. The distance is referred to as a parallel pitch P. The width of the overlapping portion between the beads 16 is referred to as a parallel lap O. The width of the formed bead 16 is considered to be the same as the bead width W calculated by the analysis device 6. The bead gap phenomenon occurs because when the bead width W of the bead 16 becomes excessively small with respect to the parallel pitch P, the material of the bead 16 does not wet-spread to the bead 16 adjacent to the bead 16.

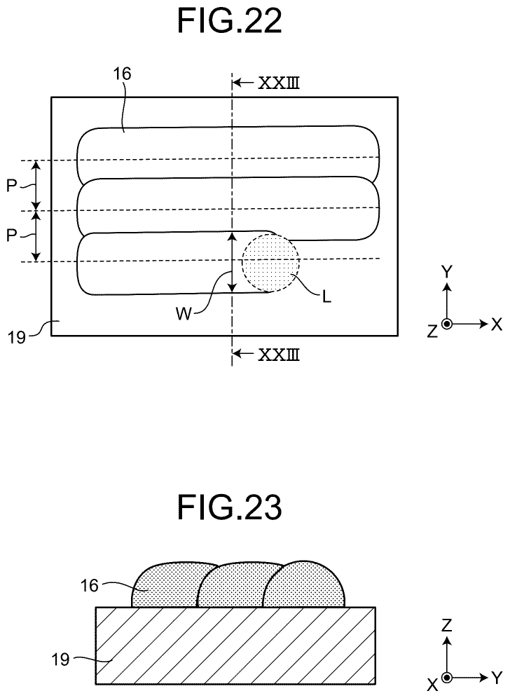

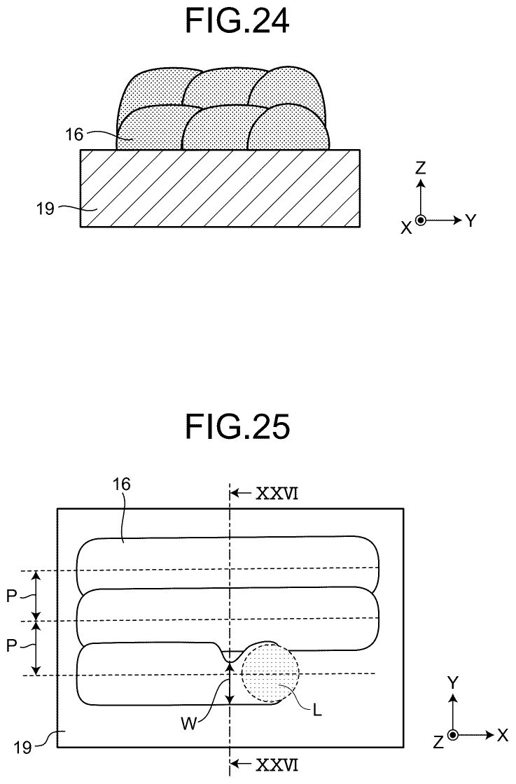

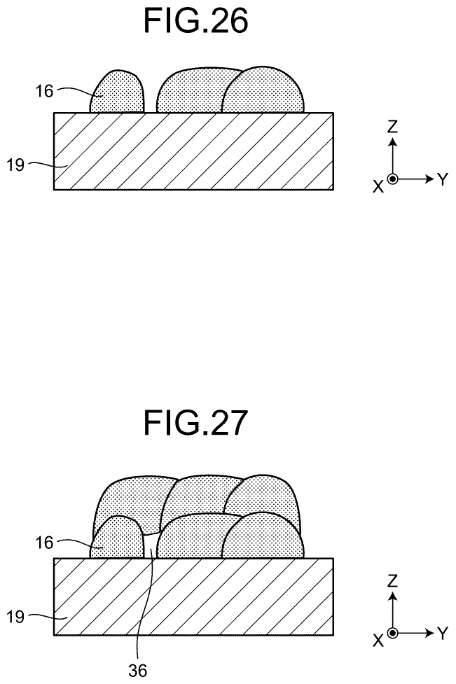

FIG. 22 is a first diagram illustrating formation of beads 16 adjacent to each other by the additive manufacturing apparatus 100 according to the first embodiment. FIG. 23 is a cross-sectional diagram taken along line XXIII-XXIII of the bead 16 illustrated in FIG. 22. FIG. 24 is a cross-sectional diagram illustrating stacking of the bead 16 on the bead 16 illustrated in FIG. 23. FIG. 25 is a second diagram illustrating formation of beads 16 adjacent to each other by the additive manufacturing apparatus 100 according to the first embodiment. FIG. 26 is a cross-sectional diagram taken along line XXVI-XXVI of the bead 16 illustrated in FIG. 25. FIG. 27 is a cross-sectional diagram illustrating stacking of the bead 16 on the bead 16 illustrated in FIG. 26.

FIGS. 22 to 24 illustrate formation of each bead 16 with the desired bead width W. FIGS. 22 and 23 illustrate sequential formation of the three beads 16 in the minus Y direction. FIG. 24 illustrates stacking of three beads 16 on the three beads 16 illustrated in FIGS. 22 and 23. In FIGS. 22 and 23, since each bead 16 is formed with an appropriate bead width W with respect to the parallel pitch P, no gap is generated between the beads 16. Therefore, even when the beads 16 are stacked as illustrated in FIG. 24, the internal defect 36 due to the bead gap phenomenon does not occur.

FIGS. 25 and 26 illustrate a state in which a portion of the bead 16 formed third among the three beads 16 has a width smaller than the desired bead width W. As illustrated in FIGS. 25 and 26, a gap is generated in a portion where the width of the bead 16 is smaller than the bead width W since the portion is not filled with the bead 16. When the beads 16 are stacked as illustrated in FIG. 27, the internal defect 36 is caused by the gap.

As described above, the bead gap phenomenon occurs when the bead width W of the bead 16 becomes excessively small with respect to the parallel pitch P. Therefore, the third determination unit 30 determines the presence or absence of the bead gap phenomenon based on the bead width W detected by the analysis device 6. The third determination unit 30 determines that the bead gap phenomenon has occurred when Formula (5) below is satisfied. Here, T is a preset threshold.
W<T . . . (5)

The threshold T is represented by, for example, the parallel pitch P, the parallel lap O, and the bead width W as shown in Formula (6) below. Here, δ is a coefficient representing tolerance from the ideal bead width W.

T=(P+O)×δ (6)

As described above, the third determination unit 30 determines the presence or absence of the bead gap phenomenon based on the result of comparing the bead width W with the threshold T calculated based on the parallel pitch P and the parallel lap O.

The third determination unit 30 obtains defect information on the internal defect 36 caused by the bead gap phenomenon based on the number of times of occurrence of the bead gap phenomenon, the duration of the bead gap phenomenon, and the difference between the threshold T and the bead width W.

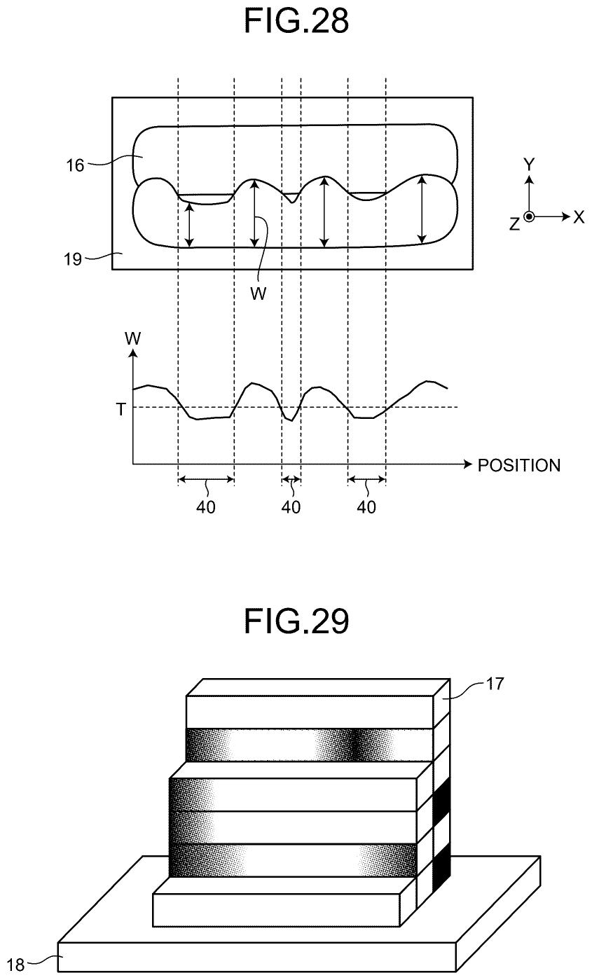

FIG. 28 is a diagram for explaining the relationship between the bead width W and the threshold T in the additive manufacturing apparatus 100 according to the first embodiment. The section 40 is a section in which the bead width W is smaller than the threshold T, that is, a section satisfying Formula (5). The smaller the bead width W is with respect to the threshold T, the larger the gap caused by the inability of the beads 16 adjacent to each other to come into contact with each other, so that a large internal defect 36 occurs. Therefore, when Formula (5) is satisfied, the third determination unit 30 can estimate the size of the internal defect 36 by a difference obtained by subtracting the bead width W from the threshold T. The third determination unit 30 can estimate the length of the internal defect 36 by obtaining the length of the section 40 satisfying Formula (5). Furthermore, the third determination unit 30 can estimate the number of internal defects 36 per unit distance by counting the number of times of satisfying Formula (5). As a result, the third determination unit 30 estimates third defect information that is defect information including at least one piece of information of the number of internal defects 36, the length of the internal defect 36, and the size of the internal defect 36. Note that the third determination unit 30 may obtain the third defect information including information other than the number of internal defects 36, the size of the internal defect 36, or the length of the internal defect 36.

Next, a method of evaluating an internal defect by the defect information evaluation unit 31 will be described. The defect information evaluation unit 31 weights the data included in each of the first defect information, the second defect information, and the third defect information, and quantifies the degree of influence on the quality of the internal defect at each position of the object 17.

The defect information includes values of a

plurality of items such as the number of internal defects, the length of the internal defect, and the size of the internal defect regarding the state of the internal defect. The weighting method is performed, for example, by multiplying a value for each item included in the defect information at a certain position by a coefficient. The defect information evaluation unit 31 calculates the defect influence degree by adding the values multiplied by the coefficients. In this manner, the defect information evaluation unit 31 calculates the defect influence degree by weighting the values of the items with a coefficient set for each of the items and summing the values of the items.

The defect influence degree is obtained by, for example, Formula (7) below. It is assumed that each coefficient of α, β, and γ can be freely set by the user for each item included in the defect information according to the degree of influence on the quality.

Defect influence degree=α×(number of internal defects)+β×(maximum size of internal defects)+γ×(length of internal defects) (7)

In Formula (7), the number of internal defects is the number of internal defects present in a section for each unit length in the traveling direction. The maximum size of internal defects is the maximum value of the size of the internal defect present in the section for each unit length in the traveling direction. The length of internal defects is the length of the internal defect present in the section for each unit length in the traveling direction. The defect information evaluation unit 31 calculates the defect influence degree to evaluate the influence of the internal defect caused by at least one of the stub phenomenon, the wire rubbing phenomenon, and the bead gap phenomenon on the quality for each position of the object 17.

Next, information stored in the machining data storage table 33 will be described. The machining data storage table 33 stores information calculated by the NC device 1, such as defect information, defect influence degree data, “Lₘ” that is a distance representing a wire melting position, and “h_{b}” that is a bead height, in association with the position information and the time information. In the machining data storage table 33, command values of the laser output, the material supply speed, and the movement speed, and feedback values of the laser output, the material supply speed, and the movement speed are stored in association with the position information and the time information. Furthermore, in the machining data storage table 33, sensor-derived information such as the bead width W and the molten pool image, and information prepared or set by the user such as the machining conditions 22, the machining program 23, and the fabrication model 32 are stored in association with the position information and the time information.

By storing these pieces of information in the machining data storage table 33, the NC device 1 can calculate the distribution of the internal defects in the entire fabrication or the average value of the data in the entire fabrication based on the stored data. In addition, by associating the position information and the time information with the information stored in the machining data storage table 33, the NC device 1 can refer to data corresponding to any position or any time by specifying the position or the time. For example, the user can utilize a movement path, a laser output, a molten pool image, or the like at a portion having a large adverse effect on quality, that is, a portion having a large defect influence degree, for confirmation of a state at the time of shaping, improvement of shaping conditions, or the like. In this manner, various types of information stored in the machining data storage table 33 can be used as traceability.

Next, a method of adding the information stored in the machining data storage table 33 to the fabrication model 32 by the defect information drawing unit 34 will be described. FIG. 29 is a diagram for explaining a method of adding information to the fabrication model 32 by the defect information drawing unit 34 in the first embodiment. FIG. 29 illustrates an example of the fabrication model 32 with data of the defect influence degree added.

The example illustrated in FIG. 29 is an example in which the magnitude of the value of the defect influence degree at each position of the fabrication model 32 is represented by color coding. In FIG. 29, color coding is represented by shading of halftone. The defect information drawing unit 34 collates the position information associated with the data of the defect influence degree with the position information of the fabrication model 32 to color-code the fabrication model 32 according to the data of the defect influence degree. The defect information drawing unit 34 outputs the generated image to the display device 10. The user can visually check the quality of the object 17 from the image displayed on the display device 10. The user can easily grasp superiority and inferiority of the quality for each position of the object 17.

The data added to the fabrication model 32 is not limited to the data of the defect influence degree, and can be designated by the user. The defect information drawing unit 34 adds data on information designated from the information stored in the machining data storage table 33 to the fabrication model 32. The defect information drawing unit 34 adds data to the fabrication model 32 by changing the color or texture for each position of the fabrication model 32 based on a value range, a sign, or the like. The user can visually check data on various types of information from the image displayed on the display device 10. The user can easily grasp the relationship between the laser output, the movement speed, or the material supply speed and the quality by referring to the fabrication model 32 with the information of the defect influence degree added and the fabrication model 32 with information such as the laser output, the movement speed, or the material supply speed added.

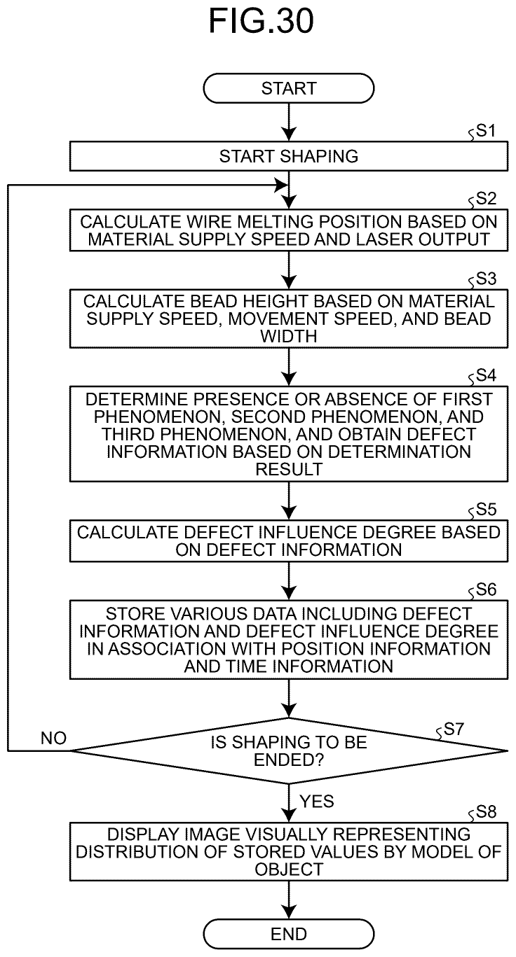

Next, a procedure of operation by the additive manufacturing apparatus 100 will be described. FIG. 30 is a flowchart illustrating a procedure of operation by the additive manufacturing apparatus 100 according to the first embodiment.

In step S1, the additive manufacturing apparatus 100 starts shaping by operating, using the NC device 1, the laser oscillator 2, the axis drive device 3, the material supply device 5, and the gas supply device 4 according to the machining program 23 and the machining conditions 22.

In step S2, the additive manufacturing apparatus 100 calculates, using the melting position calculation unit 25, the wire melting position based on the material supply speed and the laser output. The melting position calculation unit 25 calculates “Lₘ”, which is a distance representing the wire melting position.

In step S3, the additive manufacturing apparatus 100 calculates, using the bead height calculation unit 26, the bead height based on the material supply speed, the movement speed, and the bead width W. The bead height calculation unit 26 calculates “h_{b}”, which is the bead height, based on the material supply speed, the movement speed, and the bead width W detected by the analysis device 6.

In step S4, the additive manufacturing apparatus 100 determines, using the defect estimation unit 27, the presence or absence of the stub phenomenon which is the first phenomenon, the wire rubbing phenomenon which is the second phenomenon, and the bead gap phenomenon which is the third phenomenon, and obtains defect information based on the determination result. In response to the first determination unit 28 determining that the stub phenomenon has occurred, the defect estimation unit 27 calculates first defect information on an internal defect caused by the stub phenomenon using the first determination unit 28. In response to the second determination unit 29 determining that the wire rubbing phenomenon has occurred, the defect estimation unit 27 calculates second defect information on an internal defect caused by the wire rubbing phenomenon using the second determination unit 29. In response to the third determination unit 30 determining that the bead gap phenomenon has occurred, the defect estimation unit 27 calculates third defect information on an internal defect caused by the bead gap phenomenon using the third determination unit 30.

In step S5, the additive manufacturing apparatus 100 calculates the defect influence degree based on the defect information using the defect information evaluation unit 31. The defect information evaluation unit 31 weights the data included in each of the first defect information, the second defect information, and the third defect information, and calculates the defect influence degree by adding the weighted data.

In step S6, the additive manufacturing apparatus 100 stores various data including the defect information and the defect influence degree in the defect information storage unit 33a in association with the position information and the time information.

In step S7, the additive manufacturing apparatus 100 determines whether to end the shaping using the NC device 1. In response to determining not to end the shaping (step S7, No), the additive manufacturing apparatus 100 returns the procedure to step S2 and continues the shaping.

On the other hand, in response to determining to end the shaping (step S7, Yes), the defect information drawing unit 34 generates, by the model of the object 17, an image visually representing the distribution of the values stored in the defect information storage unit 33a. The defect information drawing unit 34 outputs the generated image to the display device 10. Then, in step S8, the additive manufacturing apparatus 100 displays, on the display device 10, an image visually representing the distribution of the values stored in the defect information storage unit 33a by the model of the object 17. Thus, the additive manufacturing apparatus 100 ends the operation with the procedure illustrated in FIG. 30.

Note that the NC device 1 may reflect the defect information calculated by the defect estimation unit 27 in the machining conditions 22 in a machining to be performed after the machining in which the defect information is calculated. That is, the NC device 1 may adjust, based on the defect information, the machining conditions 22 in a machining to be performed after the machining in which the defect information is calculated. In a case where the defect information is calculated in a certain machining, the NC device 1 adjusts, based on the defect information, the machining conditions 22 in a future machining that is a machining similar to the certain machining. The NC device 1 performs adjustment for preventing the occurrence of internal defects with respect to the laser output, the movement speed, the material supply speed, or the like indicated in the machining conditions 22. As a result, the NC device 1 can reduce the occurrence of internal defects in the future machining. After the defect information is calculated, the calculated defect information is reflected in the machining conditions 22 at any timing. For example, the NC device 1 may adjust the machining conditions 22 in the machining to be performed next to a certain machining based on the defect information calculated in the certain machining. Alternatively, the NC device 1 may accumulate the calculated defect information and adjust the machining conditions 22 based on a result of analyzing the accumulated defect information.

In the above description, the defect estimation unit 27 determines the presence or absence of the first phenomenon, the second phenomenon, and the third phenomenon. The defect estimation unit 27 is not limited to determine the presence or absence of all the phenomena of the first phenomenon, the second phenomenon, and the third phenomenon. The defect estimation unit 27 only needs to determine the presence or absence of at least one of the first phenomenon, the second phenomenon, and the third phenomenon. That is, the defect estimation unit 27 may include at least one of the first determination unit 28, the second determination unit 29, and the third determination unit 30.

According to the first embodiment, the additive manufacturing apparatus 100 determines the presence or absence of at least one of the stub phenomenon which is the first phenomenon, the wire rubbing phenomenon which is the second phenomenon, and the bead gap phenomenon which is the third phenomenon, and obtains defect information indicating the state of an internal defect based on the determination result. The additive manufacturing apparatus 100 can obtain defect information from various types of feedback information during shaping and sensor-derived information. The additive manufacturing apparatus 100 does not require a special measurement instrument for detecting an internal defect, and can estimate the aspect of the internal defect with a simple configuration. In addition, the additive manufacturing apparatus 100 can obtain defect information using data measured during machining. Since the additive manufacturing apparatus 100 does not need to perform measurement for detecting an internal defect after shaping, it is possible to estimate the state of the internal defect without increasing the machining time. As described above, the additive manufacturing apparatus 100 can achieve the effect of grasping the state of an internal defect in the object 17 with a simple configuration and without increasing the machining time.

The additive manufacturing apparatus 100 can ensure traceability of the object 17 by storing the defect influence degree data and the defect information in the defect information storage unit 33a in association with the position information or the time information. Furthermore, the user can easily grasp superiority and inferiority of the quality for each position of the object 17.

### Second Embodiment

In the first embodiment, the bead height is calculated based on the material supply speed, the movement speed of the laser beam L, and the bead width W. In the second embodiment, an example of obtaining bead height data by measuring the height of the formed bead 16 will be described. The additive manufacturing apparatus 100 according to the second embodiment has the same configuration as the additive manufacturing apparatus 100 illustrated in FIG. 1 except that the bead height calculation unit 26 is omitted. In the second embodiment, components identical to those in the first embodiment are denoted by the same reference signs, and operation differences from the first embodiment will be mainly described.

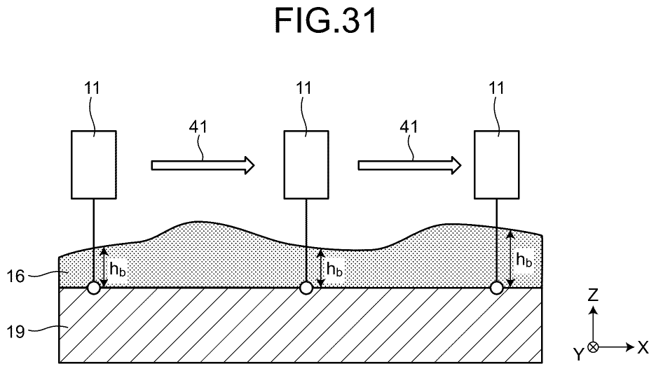

FIG. 31 is a diagram for explaining a method of obtaining bead height data by the additive manufacturing apparatus 100 according to the second embodiment. In the second embodiment, the additive manufacturing apparatus 100 measures “h_{b}”, which is the bead height of the shaped bead 16, with the height measurement instrument 11. The arrow 41 indicates the movement of the height measurement instrument 11 by the axis drive device 3. The height measurement instrument 11 outputs a measurement result of the bead height to the defect estimation unit 27. The second determination unit 29 of the defect estimation unit 27 determines the presence or absence of the wire rubbing phenomenon, which is the second phenomenon, based on the bead height acquired by measuring the height of the formed bead 16.

The additive manufacturing apparatus 100 can obtain more accurate bead height data by directly measuring the bead height with the height measurement instrument 11. The defect estimation unit 27 can estimate the internal defect caused by the wire rubbing phenomenon with high accuracy.

The measurement of the bead height by the height measurement instrument 11 is performed while associating the measurement result of the bead height with the position information. The measurement result by the height measurement instrument 11 and “h”, which is the offset distance of the machining head 8, are used for the calculation of Formulas (3) and (4) described above. The value of “h” used for the calculation is a value at the time of shaping, at the position indicated by the position information associated with the measurement result by the height measurement instrument 11.

According to the second embodiment, the additive manufacturing apparatus 100 determines the presence or absence of the wire rubbing phenomenon based on the bead height acquired by measuring the height of the formed bead 16. As a result, the additive manufacturing apparatus 100 can estimate the internal defect caused by the wire rubbing phenomenon with high accuracy.

### Third Embodiment

In the first and second embodiments, the presence or absence of the stub phenomenon and the presence or absence of the wire rubbing phenomenon are determined based on the feedback value acquired by the controlled variable input/output unit 24, the bead width W acquired by the analysis device 6, and “h_{b}” which is the calculated or measured bead height. In the third embodiment, an example in which the presence or absence of the stub phenomenon and the presence or absence of the wire rubbing phenomenon are determined based on the data acquired by a load sensor and a molten pool image will be described. In the third embodiment, components identical to those in the first or second embodiment are denoted by the same reference signs, and operation differences from the first or second embodiment will be mainly described.

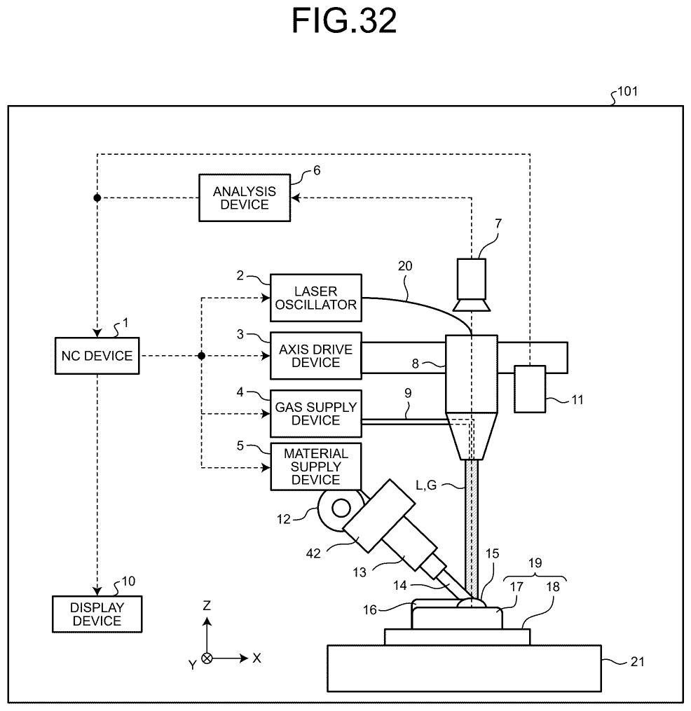

FIG. 32 is a diagram illustrating an exemplary configuration of an additive manufacturing apparatus 101 according to the third embodiment. The additive manufacturing apparatus 101 according to the third embodiment includes components similar to those of the additive manufacturing apparatus 100 illustrated in FIG. 1 and a load sensor 42. The load sensor 42 is attached to the path of the wire 14. The load sensor 42 detects a force acting on the wire 14 supplied to the workpiece 19 and a moment acting on the wire 14 supplied to the workpiece 19. The load sensor 42 detects a force in a direction parallel to the wire 14 supplied to the workpiece 19 and a moment on the XZ plane.

The first determination unit 28 of the defect estimation unit 27 determines the presence or absence of the stub phenomenon that is the first phenomenon based on the force detected by the load sensor 42 and the moment detected by the load sensor 42. In addition, the first determination unit 28 calculates first defect information that is information on an internal defect caused by the stub phenomenon based on the value of the force detected by the load sensor 42 and the value of the moment detected by the load sensor 42.

The second determination unit 29 of the defect estimation unit 27 determines the presence or absence of the wire rubbing phenomenon that is the second phenomenon based on the force detected by the load sensor 42 and the moment detected by the load sensor 42. In addition, the second determination unit 29 calculates second defect information that is information on an internal defect caused by the wire rubbing phenomenon based on the value of the force detected by the load sensor 42 and the value of the moment detected by the load sensor 42.

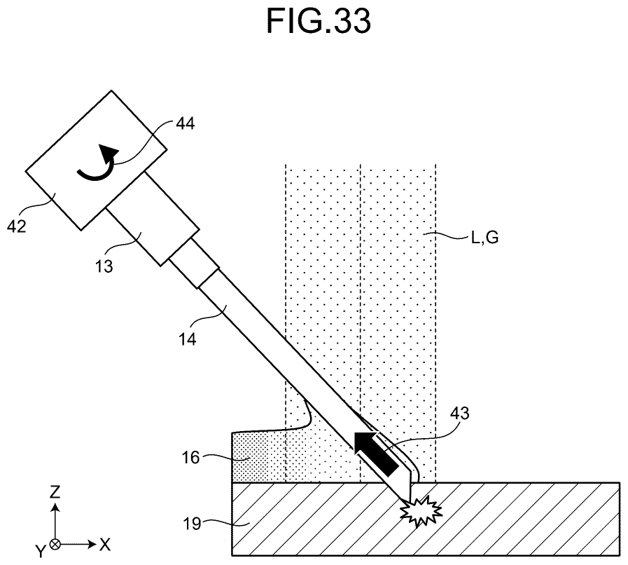

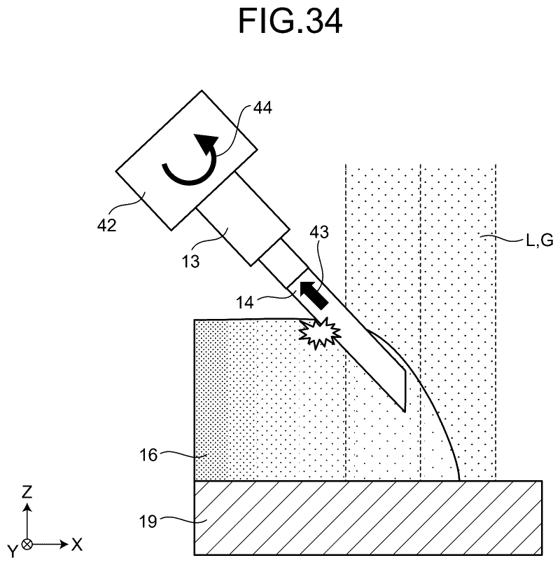

FIG. 33 is a first diagram for explaining detection of the force acting on the wire 14 and the moment acting on the wire 14 by the use of the load sensor 42 of the additive manufacturing apparatus 101 according to the third embodiment. FIG. 34 is a second diagram for explaining detection of the force acting on the wire 14 and the moment acting on the wire 14 by the use of the load sensor 42 of the additive manufacturing apparatus 101 according to the third embodiment. FIG. 33 schematically illustrates detection of the force and the moment at the time when the stub phenomenon occurs. FIG. 34 schematically illustrates detection of the force and the moment at the time when the wire rubbing phenomenon occurs.

In the state illustrated in FIG. 33, as the wire 14 in an unmelted state collides with the workpiece 19, a force 43 in a direction parallel to the wire 14 supplied to the workpiece 19 and a moment 44 on the XZ plane act on the wire 14. In the state illustrated in FIG. 34, as the wire 14 in an unmelted state interferes with the bead 16, the force 43 in a direction parallel to the wire 14 supplied to the workpiece 19 and the moment 44 on the XZ plane act on the wire 14.

The force 43 and the moment 44 acting when the stub phenomenon occurs and the force 43 and the moment 44 when the wire rubbing phenomenon occurs are different from each other in the absolute value of the force 43, the absolute value of the moment 44, and the ratio of the force 43 and the moment 44. The force 43 and the moment 44 acting when the stub phenomenon occurs and the force 43 and the moment 44 when the wire rubbing phenomenon occurs are acquired, and the relationship between the force 43 and the moment 44 when the stub phenomenon occurs and the relationship between the force 43 and the moment 44 when the wire rubbing phenomenon occurs are obtained in advance, whereby the defect estimation unit 27 can discriminate the stub phenomenon and the wire rubbing phenomenon based on the relationships obtained in advance.

In response to a determination that the stub phenomenon has occurred, the first determination unit 28 obtains the strength of the stub phenomenon based on the absolute value of the force 43, the absolute value of the moment 44, and the ratio of the force 43 and the moment 44. The strength of the stub phenomenon represents the strength of the wire 14 colliding with the workpiece 19. The first determination unit 28 can calculate the first defect information based on the strength of the stub phenomenon.

In response to a determination that the wire rubbing phenomenon has occurred, the second determination unit 29 obtains the strength of wire rubbing based on the absolute value of the force 43, the absolute value of the moment 44, and the ratio of the force 43 and the moment 44. The strength of wire rubbing is a degree of interference of the wire 14 with the bead 16; the larger the strength of wire rubbing, the more deeply the wire 14 enters the bead 16. The second determination unit 29 can calculate the second defect information based on the strength of wire rubbing.

Note that the first determination unit 28 is not limited to the one that determines the presence or absence of the stub phenomenon and calculates the first defect information based on both the force 43 and the moment 44. The second determination unit 29 is not limited to the one that determines the presence or absence of the wire rubbing phenomenon and calculates the second defect information based on both the force 43 and the moment 44. In the third embodiment, the first determination unit 28 only needs to determine the presence or absence of the stub phenomenon and calculate the first defect information based on at least one of the force 43 and the moment 44. In the third embodiment, the second determination unit 29 only needs to determine the presence or absence of the wire rubbing phenomenon and calculate the second defect information based on at least one of the force 43 and the moment 44.

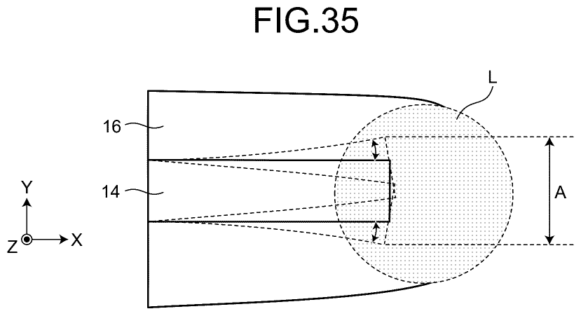

FIG. 35 is a diagram for explaining detection of the deflection width of the wire 14 from the molten pool image captured by the camera 7 of the additive manufacturing apparatus 101 according to the third embodiment. FIG. 35 schematically illustrates deflection of the distal end portion of the wire 14.

The defect estimation unit 27 determines the presence or absence of the stub phenomenon and the presence or absence of the wire rubbing phenomenon based on the result of observing the deflection width of the distal end portion of the wire 14 on the side supplied to the workpiece 19. The defect estimation unit 27 obtains the defect information on the internal defect caused by the stub phenomenon and the defect information on the internal defect caused by the wire rubbing phenomenon based on the deflection width of the distal end portion of the wire 14 on the side supplied to the workpiece 19.

When the stub phenomenon occurs, it is observed that the distal end portion of the wire 14 deflects in the XY plane due to collision of the wire 14 in an unmelted state with the workpiece 19. When the wire rubbing phenomenon occurs, it is observed that the distal end portion of the wire 14 deflects in the XY plane due to interference of the wire 14 in an unmelted state with the bead 16. In both the case where the stub phenomenon occurs and the case where the wire rubbing phenomenon occurs, the distal end portion of the wire 14 deflects in a direction perpendicular to the direction of the wire 14 supplied to the workpiece 19. In the example illustrated in FIG. 35, the distal end portion of the wire 14 deflects in the Y-axis direction.

The defect estimation unit 27 obtains the deflection width A of the distal end portion of the wire 14 from the molten pool image. The defect estimation unit 27 determines the stub phenomenon and the wire rubbing phenomenon based on the deflection width A. In response to a determination that the stub phenomenon has occurred, the first determination unit 28 obtains the strength of the stub phenomenon from the magnitude of the deflection width A. The first determination unit 28 can calculate the first defect information based on the strength of the stub phenomenon.

In response to a determination that the wire rubbing phenomenon has occurred, the second determination unit 29 obtains the strength of the wire rubbing from the magnitude of the deflection width A. The second determination unit 29 can calculate the second defect information based on the strength of wire rubbing.

According to the third embodiment, the additive manufacturing apparatus 101 determines the presence or absence of the stub phenomenon and the presence or absence of the wire rubbing phenomenon based on at least one of the force 43 and the moment 44. The additive manufacturing apparatus 101 obtains the first defect information and the second defect information based on at least one of the force 43 and the moment 44. Alternatively, the additive manufacturing apparatus 101 determines the presence or absence of the stub phenomenon and the presence or absence of the wire rubbing phenomenon based on the result of observing the deflection width A of the distal end portion of the wire 14. The additive manufacturing apparatus 101 obtains first defect information and second defect information based on the result of observing the deflection width A. The additive manufacturing apparatus 101 can reduce the influence of error due to calculation as compared with a case where determination and calculation based on feedback values are performed. As a result, the additive manufacturing apparatus 101 can estimate the internal defect caused by the stub phenomenon and the internal defect caused by the wire rubbing phenomenon with high accuracy.

Next, a hardware configuration for implementing the NC device 1 according to the first to third embodiments will be described. The NC device 1 is implemented by processing circuitry. The processing circuitry may be a circuit in which a processor executes software, or a dedicated circuit.

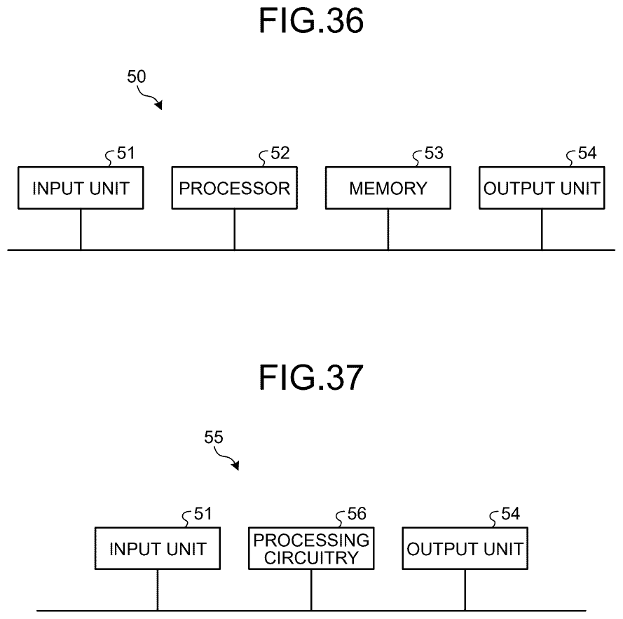

When the processing circuitry is implemented by software, the processing circuitry is, for example, a control circuit 50 illustrated in FIG. 36. FIG. 36 is a diagram illustrating an exemplary configuration of the control circuit 50 according to the first to third embodiments. The control circuit 50 includes an input unit 51, a processor 52, a memory 53, and an output unit 54.

The input unit 51 is an interface circuit that receives data input from the outside of the control circuit 50 and provides data to the processor 52. The output unit 54 is an interface circuit that transmits data from the processor 52 or the memory 53 to the outside of the control circuit 50. In a case where the processing circuitry is the control circuit 50 illustrated in FIG. 36, the processor 52 reads and executes a program stored in the memory 53, thereby implementing the functions of the NC device 1. The memory 53 is also used as a temporary memory for each process performed by the processor 52.

When the processing circuitry is the control circuit 50 illustrated in FIG. 36, the NC device 1 is implemented by software, firmware, or a combination of software and firmware. Software or firmware is described as a program and stored in the memory 53. In the processing circuitry, the processor 52 reads and executes the program stored in the memory 53, thereby implementing each function of the NC device 1. That is, the processing circuitry includes the memory 53 for storing the programs that result in the processing of the NC device 1. It can also be said that these programs cause a computer to execute the procedures and methods for the NC device 1.

The processor 52 is a central processing unit (CPU), a processing device, an arithmetic device, a microprocessor, a microcomputer, a processor, or a digital signal processor (DSP). Examples of the memory 53 include a non-volatile or volatile semiconductor memory, a magnetic disk, a flexible disk, an optical disc, a compact disc, a mini disc, a digital versatile disc (DVD), and the like. Examples of the non-volatile or volatile semiconductor memory include a random access memory (RAM), a read only memory (ROM), a flash memory, an erasable programmable read only memory (EPROM), an electrically erasable programmable read only memory (EEPROM, registered trademark), and the like.

FIG. 36 is an example of hardware for implementing the NC device 1 with the general-purpose processor 52 and memory 53, but the NC device 1 may be implemented by a dedicated hardware circuit. FIG. 37 is a diagram illustrating an exemplary configuration of a dedicated hardware circuit 55 according to the first to third embodiments.

The dedicated hardware circuit 55 includes the input unit 51, the output unit 54, and processing circuitry 56. The processing circuitry 56 is a single circuit, a composite circuit, a programmed processor, a parallel programmed processor, an application specific integrated circuit (ASIC), a field programmable gate array (FPGA), or a circuit that is a combination thereof. Note that the NC device 1 may be implemented by combining the control circuit 50 and the hardware circuit 55.

In the first to third embodiments, an example in which the function of the defect estimation device is provided in the NC device 1 has been described. The defect estimation device may be a device outside the NC device 1. The defect estimation device that is a device outside the NC device 1 is communicably connected to the NC device 1. The defect estimation device outside the NC device 1 includes components similar to the melting position calculation unit 25, the bead height calculation unit 26, the defect estimation unit 27, the defect information evaluation unit 31, the defect information storage unit 33a, and the defect information drawing unit 34 of the NC device 1 described in the first to third embodiments. The defect estimation device outside the NC device 1 acquires information from the NC device 1 and estimates the state of an internal defect. The defect estimation device outside the NC device 1 can be implemented by the control circuit 50 illustrated in FIG. 35 or the dedicated hardware circuit 55 illustrated in FIG. 36.

The defect estimation device may be provided in a server device constructed in a cloud environment. The cloud environment includes computer resources provided in a cloud service platform. Specific modes of distribution or integration of the components described in the first to third embodiments are not limited to those described in the first to third embodiments. All or some of the components of the defect estimation device may be configured to be distributed or integrated functionally or physically in any unit. The components described in the first to third embodiments may be distributed to the NC device 1 and the server device. For example, the NC device 1 may include the melting position calculation unit 25, the bead height calculation unit 26, the defect estimation unit 27, the defect information evaluation unit 31, and the defect information drawing unit 34, and the server device may include the defect information storage unit 33a.

The configurations described in the above-mentioned embodiments indicate examples of the contents of the present disclosure. The configurations of the embodiments can be combined with another well-known technique. The configurations of the embodiments may be combined with each other as appropriate. Some of the configurations of the embodiments can be omitted or changed without departing from the gist of the present disclosure.

### Reference Signs List

1 NC device; 2 laser oscillator; 3 axis drive gas supply device; 5 material supply device; 6 device; 4 analysis device; 7 camera; 8 machining head; 9 gas nozzle; 10 display device; 11 height measurement instrument; 12 material supply source; 13 material supply nozzle; 14 wire; 15 molten pool; 16 bead; 17 object; 18 base material; 19 workpiece; 20 fiber cable; 21 stage; 22 machining condition; 23 machining program; 24 controlled variable input/output unit; 25 melting position calculation unit; 26 bead height calculation unit; 27 defect estimation unit; 28 first determination unit; 29 second determination unit; 30 third determination unit; 31 defect information evaluation unit; 32 fabrication model; 33 machining data storage table; 33a defect information storage unit; 34 defect information drawing unit; 36 internal defect; 37, 38, 39, 40 section; 41 arrow; 42 load sensor; 43 force; 44 moment; 50 control circuit; 51 input unit; 52 processor; 53 memory; 54 output unit; 55 hardware circuit; 56 processing circuitry; 100, 101 additive manufacturing apparatus; CN center line; G shielding gas; L laser beam; LN boundary line; LP wire inrush point; MP distal end position; RP machining reference point.

1-23. (canceled)

24. A defect estimation device that estimates a state of an internal defect that is a gap formed inside an object manufactured by supplying a material to a workpiece and stacking beads formed of the material melted using a beam, the defect estimation device comprising:
defect estimation circuitry to determine presence or absence of a phenomenon in which the material unmelted is rubbed against the bead to generate a trace on the bead, and obtain defect information indicating the state of the internal defect based on a determination result.

25. The defect estimation device according to claim 24, wherein the defect estimation circuitry determines presence or absence of the phenomenon based on a bead height that is a height of the bead in a direction in which the bead is stacked.

26. The defect estimation device according to claim 25, wherein the defect estimation circuitry determines presence or absence of the phenomenon based on a relationship between the bead height and an inrush point that is a position where the material enters an irradiation range of the beam.

27. The defect estimation device according to claim 26, wherein the defect estimation circuitry obtains the defect information on the internal defect caused by the phenomenon based on at least one of number of times of occurrence of the phenomenon, duration of the phenomenon, and a distance between the inrush point and a machining surface that is a surface of the workpiece on which the bead is formed.

28. The defect estimation device according to claim 25, comprising
bead height calculation circuitry to calculate the bead height based on supply speed of the material, movement speed of the beam on the workpiece, and width of the bead, wherein
the defect estimation circuitry determines presence or absence of the phenomenon based on the bead height calculated.

29. The defect estimation device according to claim 24, wherein the defect estimation circuitry determines presence or absence of a first phenomenon in which the material unmelted collides with the workpiece and a second phenomenon in which the material unmelted is rubbed against the bead to generate a trace on the bead, and obtains the defect information based on a determination result.

30. The defect estimation device according to claim 29, wherein the defect estimation circuitry determines presence or absence of the first phenomenon and presence or absence of the second phenomenon based on at least one of a force acting on the material supplied to the workpiece and a moment acting on the material supplied to the workpiece, and
obtains the defect information on the internal defect caused by the first phenomenon and the defect information on the internal defect caused by the second phenomenon based on at least one of a value of the force and a value of the moment.

31. The defect estimation device according to claim 29, wherein the defect estimation circuitry determines presence or absence of the first phenomenon and presence or absence of the second phenomenon based on a result of observing a deflection width of a distal end portion of the material on a side where the material is supplied to the workpiece, and
obtains the defect information on the internal defect caused by the first phenomenon and the defect information on the internal defect caused by the second phenomenon based on the deflection width.

32. The defect estimation device according to claim 29, comprising
melting position calculation circuitry to calculate a melting position based on supply speed of the material and output of the beam in a beam source, the melting position being a position at which temperature of the material reaches a melting point of the material, wherein
the defect estimation circuitry determines presence or absence of the first phenomenon based on the melting position calculated.

33. The defect estimation device according to claim 32, wherein the defect estimation circuitry determines presence or absence of the first phenomenon based on a positional relationship between the melting position calculated and a machining surface of the workpiece on which the bead is formed.

34. The defect estimation device according to claim 33, wherein the defect estimation circuitry obtains the defect information on the internal defect caused by the first phenomenon based on at least one of number of times of occurrence of the first phenomenon, duration of the first phenomenon, and a distance between the melting position and the machining surface.

35. The defect estimation device according to claim 24, wherein the defect estimation circuitry determines presence or absence of a second phenomenon that is the phenomenon in which the material unmelted is rubbed against the bead to generate a trace on the bead and a third phenomenon in which a gap is generated between beads adjacent to each other, and obtains the defect information based on a determination result.

36. The defect estimation device according to claim 35, wherein the defect estimation circuitry determines presence or absence of the third phenomenon based on a result of comparing width of the bead with a threshold, calculated based on a pitch at which beads are arranged in parallel on a machining surface that is a surface of the workpiece on which the beads are formed and width of a portion where the beads overlap each other.

37. The defect estimation device according to claim 36, wherein the defect estimation circuitry obtains the defect information on the internal defect caused by the third phenomenon based on number of times of occurrence of the third phenomenon, duration of the third phenomenon, and a difference between the threshold and the width of the bead.

38. The defect estimation device according to claim 24, wherein the defect estimation circuitry determines presence or absence of a first phenomenon in which the material unmelted collides with the workpiece, a second phenomenon that is the phenomenon in which the material unmelted is rubbed against the bead to generate a trace on the bead, and a third phenomenon in which a gap is generated between beads adjacent to each other, and obtains the defect information based on a determination result.

39. The defect estimation device according to claim 24, comprising a defect information evaluation circuitry to evaluate the internal defect by obtaining, based on the defect information, a defect influence degree that numerically represents magnitude of influence of the internal defect on quality of the object.

40. The defect estimation device according to claim 39, comprising
defect information storage circuitry to store the defect information, wherein
in the defect information storage circuitry, the defect information and at least one of the defect influence degree, an image obtained by capturing formation of the bead, a feedback value of supply speed of the material, a feedback value of movement speed of the beam on the workpiece, and a feedback value of output of the beam are stored in association with position information or time information.

41. A numerical control device that controls an additive manufacturing apparatus that manufactures an object by supplying a material to a workpiece and stacking beads formed of the material melted using a beam on the workpiece, the numerical control device comprising:
defect estimation circuitry to determine presence or absence of a phenomenon in which the material unmelted is rubbed against the bead to generate a trace on the bead, and obtain, based on a determination result, defect information indicating a state of an internal defect that is a gap formed inside the object.

42. An additive manufacturing apparatus comprising:
the numerical control device according to claim 41, and
shaping circuitry to manufacture the object by supplying the material to the workpiece and stacking beads formed of the material melted using the beam.

43. A defect estimation method for estimating, by a defect estimation device, a state of an internal defect that is a gap formed inside an object manufactured by supplying a material to a workpiece and stacking beads formed of the material melted using a beam, the defect estimation method comprising:
determining presence or absence of a phenomenon in which the material unmelted is rubbed against the bead to generate a trace on the bead, and obtaining defect information indicating the state of the internal defect based on a determination result.
